(19) United States
(12) Patent Application Publication
(10) Pub. No.: US 2026/0186632 A1
(43) Pub. Date: Jul. 2, 2026

(54) SYSTEMS AND METHODS FOR CONFIGURING INPUT AFFORDANCES OF A WEARABLE DEVICE

(71) Applicant: Meta Platforms Technologies, LLC, Menlo Park, CA (US)

(72) Inventors: Xiang Li, Issaquah, WA (US); Benjamin Neal Bethurum, North Vancouver (CA)

(21) Appl. No.: 19/366,508

(22) Filed: Oct. 22, 2025

Related U.S. Application Data
(63) Continuation of application No. 19/324,079, filed on Sep. 9, 2025, now abandoned.
Application No. 19/324,079 is a continuation-in-part of application No. 19/209,771, filed on May 15, 2025, now abandoned.
(60) Provisional application No. 63/649,289, filed on May 17, 2024.
(60) Provisional application No. 63/649,907, filed on May 20, 2024.
(60) Provisional application No. 63/662,349, filed on Jun. 20, 2024.

(51) Int. Cl. G06F 3/0484; G06F 3/02; G06F 3/0482; G06F 3/0488

(52) U.S. Cl. CPC G06F 3/0484; G06F 3/02; G06F 3/0482; G06F 3/0488

(57) ABSTRACT

Systems and methods for configuring input affordances of a wearable device are disclosed. An example method includes detecting a first user input at a touch-input affordance of input affordances of a head-wearable device and associated with commands available at the head-wearable device, and, in response to detecting the first user input, causing performance of the first user-assignable command at the head-wearable device. The touch-input affordance is associated with a first user-assignable command of the commands. The method includes detecting a second user input at a button-input affordance of the input affordances of the head-wearable device and associated with the commands available at the head-wearable device, and, in response to detecting the second user input, causing performance of the second user-assignable command at the head-wearable device. The button-input affordance is associated with a second user-assignable command of the commands.

### RELATED APPLICATION

This application is a continuation of U.S. patent application Ser. No. 19/324,079, filed Sep. 9, 2025, entitled “Systems And Methods For Configuring Input Affordances Of A Wearable Device”, which is a continuation-in-part of U.S. patent application Ser. No. 19/209,771, filed on May 15, 2025, entitled “Systems And Methods Of Using Wearable Devices To Intermittently Capture Data For Invoking An Artificial Intelligence Agent,” which claims priority to U.S. Provisional Application Ser. No. 63/649,289, filed May 17, 2024, entitled “Methods Of Interacting With Wearable Devices As A Result Of Artificial Intelligence Determinations, Devices, And Systems Thereof,” U.S. Provisional Application Ser. No. 63/649,907, filed May 20, 2024, entitled “Artificial-Intelligence-Assisted Activity Management And Interaction Assistance For Use With Smart Glasses, And Devices, Systems, And Methods Thereof,” and U.S. Provisional Application Ser. No. 63/662,349, filed Jun. 20, 2024, entitled “Utilizing Auto-Recognize And Auto-Capture Features To Facilitate AI-Related Interactions For Smart And Augmented Reality Glasses, And Devices, Systems, And Methods Thereof,” each of which is incorporated herein by reference.

### TECHNICAL FIELD

This relates generally to wearable devices, including, but not limited to, head-worn devices, including assistive systems, such as artificial intelligence agents, and, more specifically, wearable devices for invoking artificial intelligence agents for supplementing and/or augmenting user interactions with their environment.

### BACKGROUND

Existing artificial intelligence systems rely on user hands-on inputs for invocation and interaction with the real world. Such systems fail to provide users with timely and useful feedback. Additionally, reliance on hands-on inputs to invoke artificial intelligence systems increases user friction and decreases accessibility. These example drawbacks limit the experiences of users and place a high burden on users for accessing/interacting with the artificial intelligence systems.

As such, there is a need to address one or more of the above-identified challenges. A brief summary of solutions to the issues noted above is described below.

### SUMMARY

In one example embodiment, a wearable device for invoking and interacting with an artificial intelligence agent is described herein. The example wearable device can be a head-wearable device including one or more of a display, one or more sensors, one or more imaging devices, one or more microphones, and one or more programs. The one or more programs are executed by one or more processors and include instructions for capturing first environmental data. The first environmental data includes one or more of first image data, first audio data, and first sensor data intermittently captured by the wearable device. The instructions also cause the performance of, in response to an indication that the first environmental data satisfies an artificial intelligence (AI) agent invocation trigger, initiating, at the wearable device, an AI agent, and capturing second environmental data. The second environmental data includes one or more of second image data, second audio data, and second sensor data continuously captured by the wearable device. The instructions further cause the performance of determining, by the AI agent, a context-based user request based on, at least, the second environmental data, and an AI response for responding to the context-based user request. The instructions further cause the performance of generating, by the AI agent, the AI response using, at least, the second environmental data, and presenting, at the wearable device, the AI response.

In another example embodiment, a method for invoking and interacting with an artificial intelligence agent at a wearable device is described herein. The method includes capturing first environmental data. The first environmental data includes one or more of first image data, first audio data, and first sensor data intermittently captured by the wearable device. The method includes, in response to an indication that the first environmental data satisfies an AI agent invocation trigger, initiating, at the wearable device, an AI agent, and capturing second environmental data. The second environmental data includes one or more of second image data, second audio data, and second sensor data continuously captured by the wearable device. The method also includes determining, by the AI agent, a context-based user request based on, at least, the second environmental data, and an AI response for responding to the context-based user request. The method further includes generating, by the AI agent, the AI response using, at least, the second environmental data, and presenting, at the wearable device, the AI response.

In yet another example embodiment, a non-transitory, computer-readable storage medium including executable instructions that, when executed by one or more processors of a wearable device (e.g., a head-wearable device), cause the one or more processors to invoke and interact with an AI agent is described herein. The executable instructions, when executed by one or more processors, cause the one or more processors to capture first environmental data. The first environmental data includes one or more of first image data, first audio data, and first sensor data intermittently captured by the wearable device. The executable instructions, when executed by one or more processors, cause the one or more processors to, in response to an indication that the first environmental data satisfies an AI agent invocation trigger, initiate, at the wearable device, an AI agent, and capture second environmental data. The second environmental data includes one or more of second image data, second audio data, and second sensor data continuously captured by the wearable device. The executable instructions, when executed by one or more processors, cause the one or more processors to determine, by the AI agent, a context-based user request based on, at least, the second environmental data, and an AI response for responding to the context-based user request. The executable instructions, when executed by one or more processors, cause the one or more processors to generate, by the AI agent, the AI response using, at least, the second environmental data, and present, at the wearable device, the AI response.

Instructions that cause performance of the methods and operations described herein can be stored on a non-transitory, computer-readable storage medium. The non-transitory, computer-readable storage medium can be included on a single electronic device or spread across multiple electronic devices of a system (e.g., a computing system). A non-exhaustive list of electronic devices that can either alone or in combination (e.g., a system) perform the method and operations described herein includes an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory, computer-readable storage medium.

The devices and/or systems described herein can be configured to include instructions that cause the performance of methods and operations associated with the presentation and/or interaction with an XR headset. These methods and operations can be stored on a non-transitory, computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an XR headset (e.g., an MR headset or a pair of AR glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device), which together can include instructions for performing methods and operations associated with the presentation and/or interaction with an XR system (i.e., the XR headset would be part of a system that includes one or more additional devices). Multiple combinations with different related devices are envisioned but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1E illustrate invocation of an artificially intelligent agent at one or more wearable devices, in accordance with some embodiments.

FIGS. 2A and 2B illustrate artificial intelligence notes generated by an artificial intelligence agent of a wearable device, in accordance with some embodiments.

FIGS. 3A and 3B show invocation of the artificial intelligence agent using a touch input, in accordance with some embodiments.

FIG. 4 illustrates additional invocations of an artificial intelligence agent, in accordance with some embodiments.

FIGS. 5A and 5B illustrate the use of an artificial intelligence agent for generating responses, in accordance with some embodiments.

FIG. 6 illustrates an additional invocation of an artificial intelligence agent, in accordance with some embodiments.

FIG. 7 illustrates an example of a reactive mode for activating the AI agent, in accordance with some embodiments.

FIG. 8 illustrates an example of a proactive mode for activating the AI agent, in accordance with some embodiments.

FIGS. 9A-9C illustrate user interfaces for modifying and/or defining objectives of AI invocation systems and/or assistive systems, in accordance with some embodiments.

FIG. 10 shows a head-worn device 120 for use with embodiments described herein.

FIG. 11 shows a block diagram illustrating components of an example assistive system, in accordance with some embodiments.

FIGS. 12A and 12B illustrate block diagrams of example input frameworks for interacting with affordances of a head-worn device, in accordance with some embodiments.

FIGS. 12D-12F illustrate example configuration user interfaces for adjusting operation of a wearable device, in accordance with some embodiments.

FIGS. 13A and 13B illustrate logic diagrams illustrating reactive and proactive activation modes of an artificial intelligence agent, in accordance with some embodiments.

FIG. 14 shows a flow chart of a method of invoking an artificial intelligence agent at a wearable device.

FIGS. 15A-15C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of XRs such as MR and AR systems. MRs and ARs, as described herein, are any superimposed functionality and/or sensory-detectable presentation provided by MR and AR systems within a user's physical surroundings. Such MRs can include and/or represent virtual realities (“VRs”) and VRs in which at least some aspects of the surrounding environment are reconstructed within the virtual environment (e.g., displaying virtual reconstructions of physical objects in a physical environment to prevent the user from colliding with the physical objects in a surrounding physical environment). In the case of MRs, the surrounding environment that is presented through a display is captured via one or more sensors configured to capture the surrounding environment (e.g., a camera sensor or time-of-flight (“ToF”) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive. Any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities, and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile-wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device). In other words, the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, a user's hand or another finger, the user's leg, a couch, or a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, or strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting, and features can be removed or added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (“HIPD”), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid-state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid-state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth Low Energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) Global Positioning System (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors (used interchangeably with neuromuscular-signal sensors); (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein, biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; and (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory, computer-readable storage media are physical devices or storage media that can be used to store electronic data in a non-transitory form (e.g., such that the data is stored permanently until it is intentionally deleted and/or modified).

### Invocation of an AI Agent at a Wearable Device

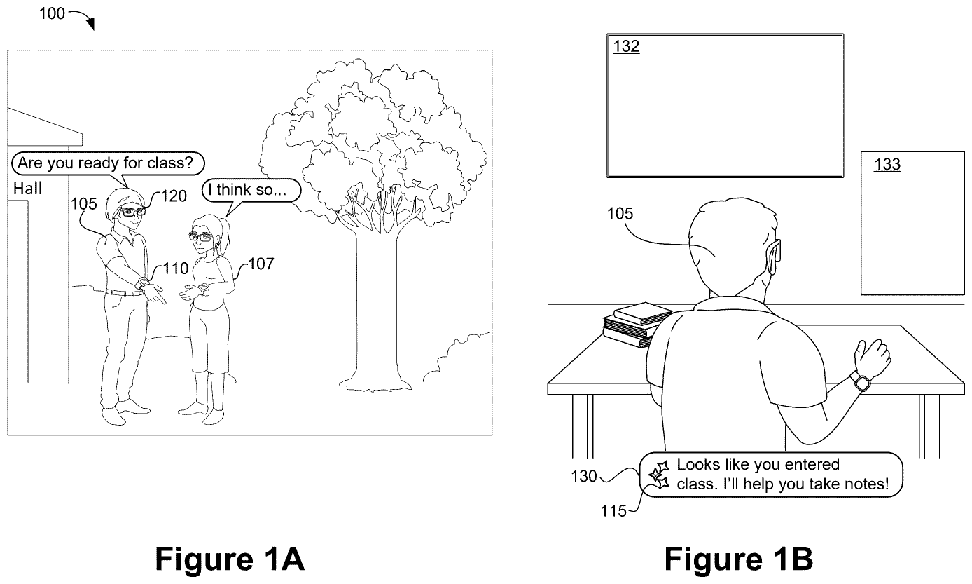

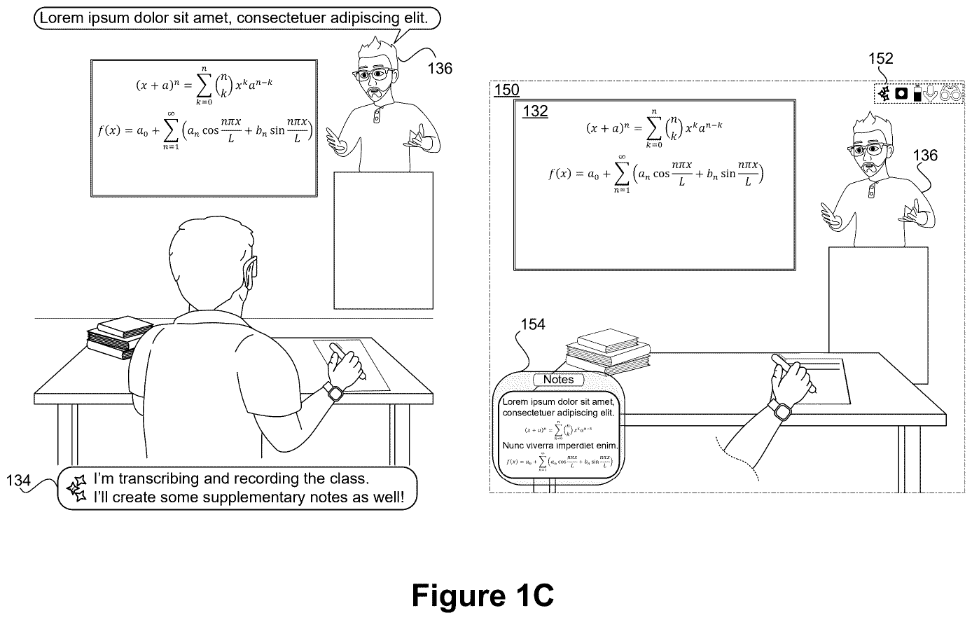

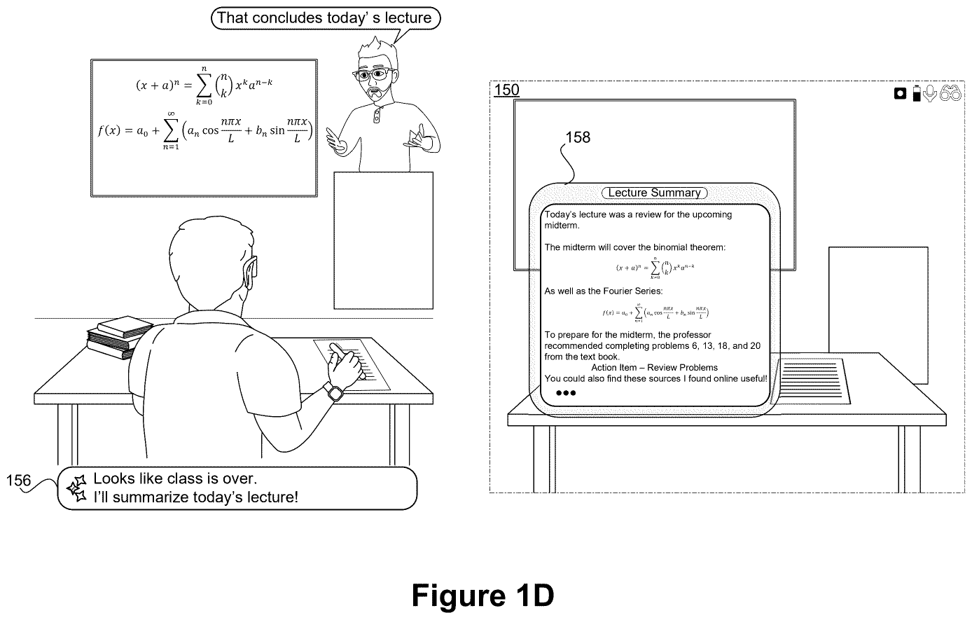

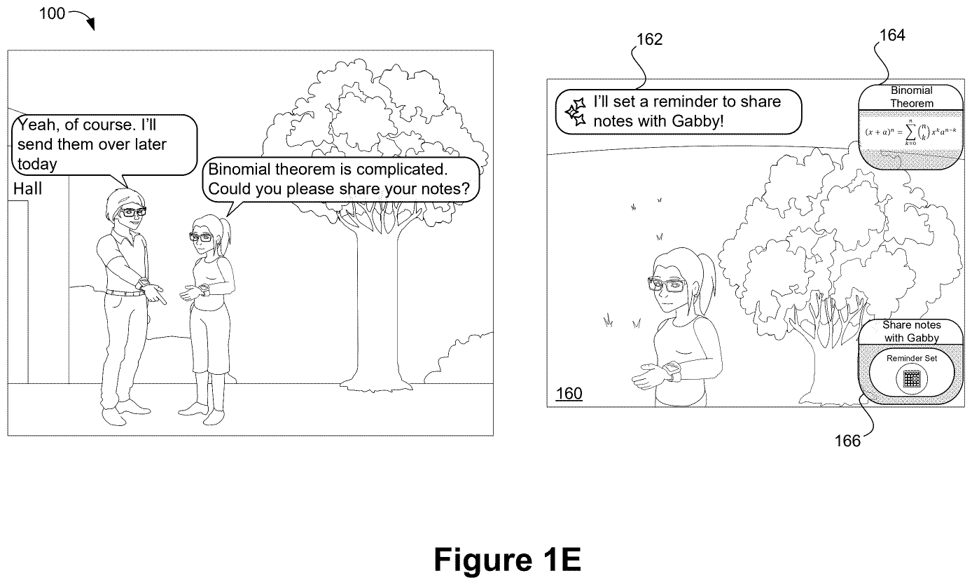

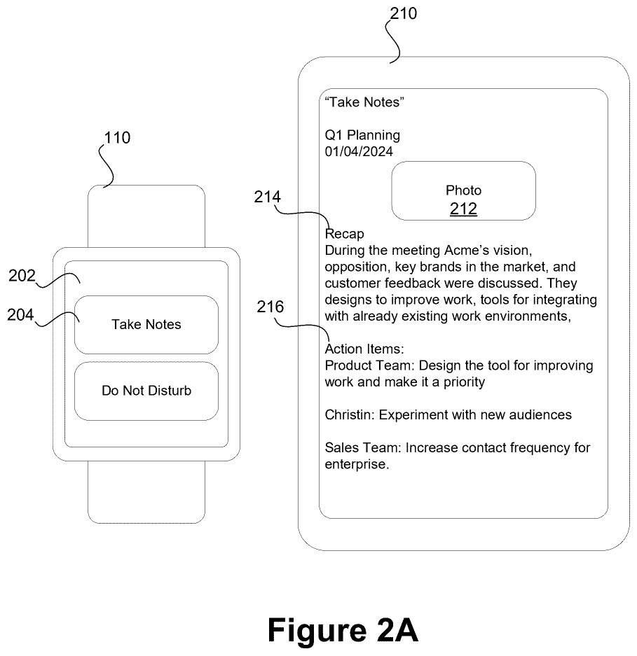

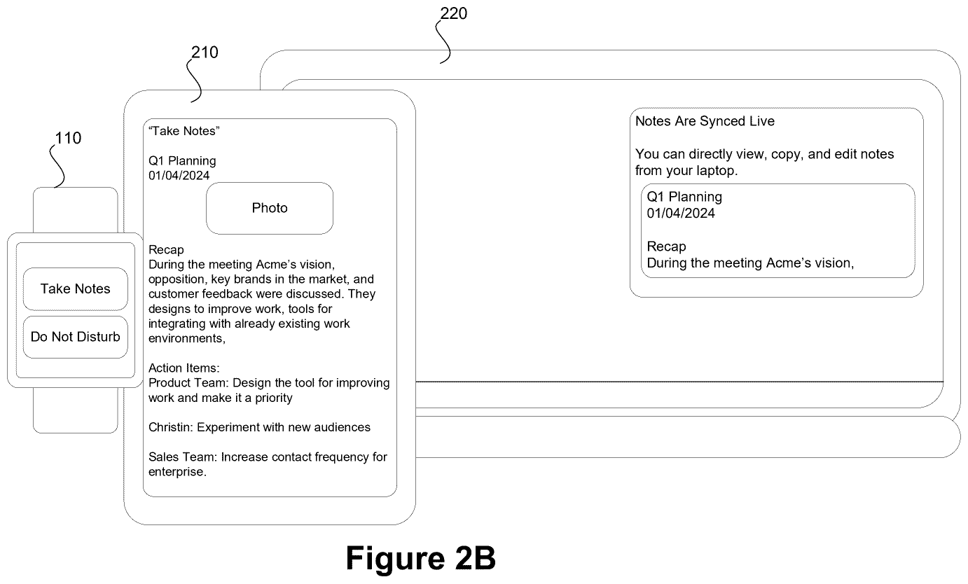

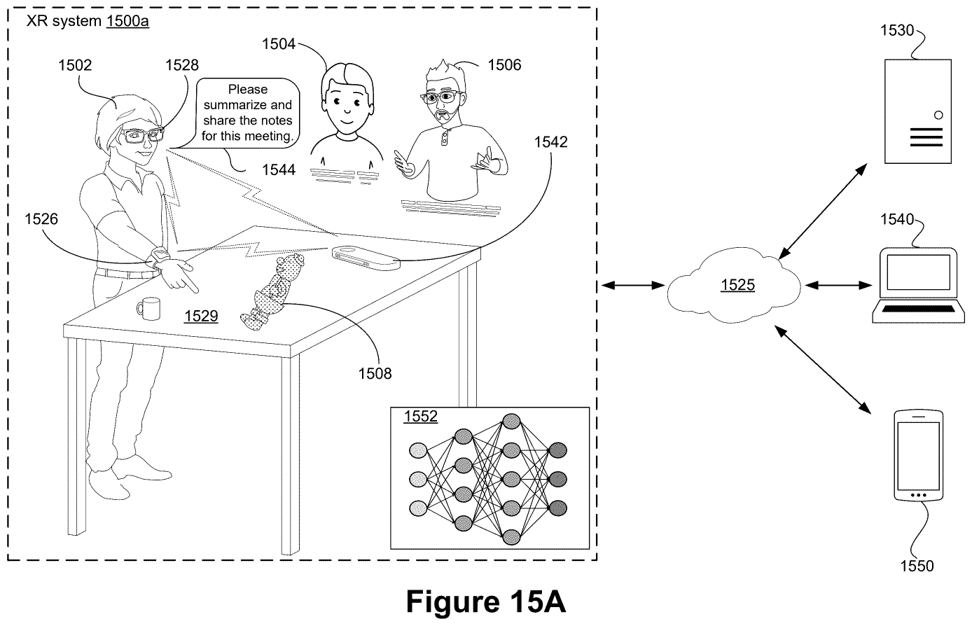

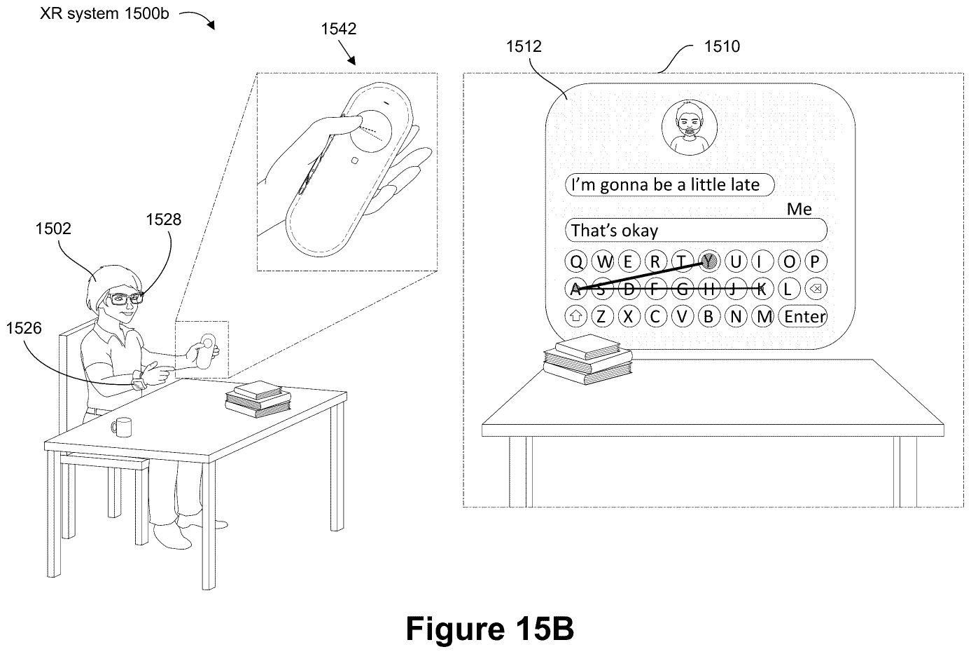

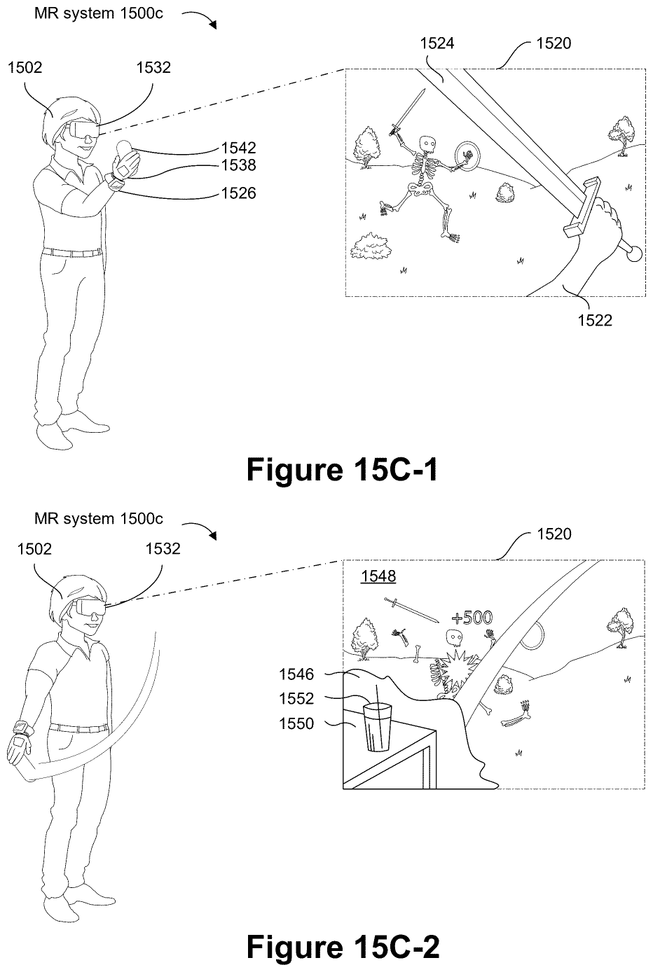

FIGS. 1A-1E illustrate invocation of an artificially intelligent agent at one or more wearable devices, in accordance with some embodiments. An AI invocation system 100 shown and described in reference to FIGS. 1A-1E provides example invocations of an AI agent at wearable devices, such as a wrist-wearable device 110 and a head-wearable device 120 donned by a user 105. The AI invocation system 100 includes at least the wrist-wearable device 110 and the head-wearable device 120 donned by the user 105. The AI invocation system 100 can include other wearable devices worn by the user 105, such as smart textile-based garments (e.g., wearable bands, shirts, etc.), and/or other electronic devices, such as an HIPD 1542, a computer 1540 (e.g., a laptop), a mobile device 1550 (e.g., a smartphone, a tablet), and/or another electronic device described below in reference to FIGS. 15A-15C-2. The AI invocation system 100, the wearable devices, and the electronic devices can be communicatively coupled via a network (e.g., internet, cellular, near field, Wi-Fi, personal area network, wireless LAN). The AI invocation system 100 further includes an AI agent 115 (represented by star symbols) that can be invoked by the user 105 via one or more devices of the AI invocation system 100 (e.g., a wearable device, such as a wrist-wearable device 110 and/or a head-wearable device 120). Alternatively or in addition, in some embodiments, the AI agent 115 can be invoked in accordance with a determination that an AI agent trigger condition is present (as discussed below).

As described below in reference to FIG. 15A, the wrist-wearable device 110 (analogous to wrist-wearable device 1526; FIGS. 15A-15C-2) can include a display, an imaging device (e.g., a camera), a microphone, a speaker, input surfaces (e.g., touch input surfaces, mechanical inputs, etc.), and one or more sensors (e.g., biopotential sensors (e.g., EMG sensors), proximity sensors, ToF sensors, sensors of an IMU, capacitive sensors, strain sensors, etc.). Similarly, the head-wearable device 120 (analogous to AR device 1528 and MR device 1532; FIGS. 15A-15C-2) can include another imaging device, an additional microphone, an additional speaker, additional input surfaces (e.g., touch input surfaces, mechanical inputs, etc.), and one or more additional sensors (e.g., biopotential sensors (e.g., EMG sensors), gaze trackers, proximity sensors, ToF sensors, sensors of an IMU, capacitive sensors, strain sensors, etc.). In some embodiments, the head-wearable device 120 includes a display.

Turning to FIG. 1A, the user 105 is at school discussing an upcoming class with a classmate 107. The user 105 is donning the head-wearable device 120 and the wrist-wearable device 110. The wearable devices capture first environmental data. The first environmental data includes one or more of first image data, first audio data, and first sensor data intermittently captured by the wearable devices. More specifically, the head-wearable device 120 and/or wrist-wearable device 110 intermittently capture data of the user 105's surroundings. The wearable devices capture the first environmental data intermittently such that battery power of the wearable devices is conserved (e.g., by reducing the amount of superfluous data captured and discarded, as well as reducing power provided to individual components).

The AI invocation system 100 uses the first environmental data to determine whether an AI agent invocation trigger is satisfied. Non-limiting examples of AI agent invocation triggers include predetermined location triggers (e.g., location data associated with a location of interest, such as a classroom, a meeting room, a museum, a concert, etc.); gaze-based triggers (e.g., eye tracking data indicating user focus on an (animate or inanimate) object or person, eye tracking data indicating gaze dwell, etc.); image-based triggers (e.g., recognition and/or detection of (animate or inanimate) objects of interest, user contacts or persons of interest, facial features, emotions, etc.); event triggers (e.g., calendar events, scheduled events, entertainment events (e.g., television shows, sports broadcasts, etc.), sporting events etc.); audio triggers (e.g., keywords, wake-words, voice commands, voice requests, etc.); user input triggers; and/or other triggers described herein. Example AI agent invocation triggers are discussed below in reference to FIGS. 1B-14.

The AI invocation system 100, in response to an indication that the first environmental data satisfies an AI agent invocation trigger, initiates, at a wearable device, the AI agent and captures second environmental data. The second environmental data includes one or more of second image data, second audio data, and second sensor data continuously captured by the wearable device. In other words, before the AI agent 115 is invoked, the AI invocation system 100 causes the wearable devices to capture data from the user's surroundings periodically to determine when to invoke the AI agent 115, and, once the AI agent 115 is invoked, the AI invocation system 100 causes the wearable devices to capture data from the user's surroundings continuously, which can be provided to the AI agent for analysis. In this way, the AI agent 115 is not always active, which extends the battery life of the wearable devices.

For example, in FIG. 1A, the AI invocation system 100, using the first environmental data, determines that an AI agent invocation trigger is not satisfied and forgoes invoking the AI agent 115. Because the AI agent 115 is not invoked, the AI invocation system 100 also forgoes causing the wearable devices (or other communicatively coupled devices) to collect second environmental data.

Turning to FIG. 1B, the user 105 enters a classroom. The AI invocation system 100, using the first environmental data, determines that an AI agent invocation trigger is satisfied, invokes the AI agent 115, and causes, at least, the wearable devices to continuously capture second environmental data. For example, the first environmental data can include location data that indicates that the head-wearable device 120 and/or the wrist-wearable device 110 is within a classroom (e.g., predefined by the user and/or automatically defined by user behavior), and the AI invocation system 100 can invoke the AI agent based on the location data. Alternatively, or in addition, the first environmental data can include image data, including representations of a whiteboard 132 and a lectern 133, and the AI invocation system 100 can invoke the AI agent based on the recognition of the whiteboard 132 and/or the lectern 133 (which are indicative of the user 105 being in a classroom and/or the start of an event (e.g., a lecture)). In yet another example, the first environmental data can include a schedule of the user 105, time data, and location data; and the AI invocation system 100 can invoke the AI agent based on a start time of a scheduled lecture and the location of the user 105.

The AI agent 115, when invoked, can silently and/or audibly notify the user 105. For example, the AI agent 115, when invoked, can cause a display of the wrist-wearable device 110, the head-wearable device 120, and/or another communicatively coupled device to present a user interface element to communicate and/or interact with the user 105 (e.g., first UI element 130 communicating with the user 105). Alternatively, or in addition, the AI agent 115, when invoked, can use a speaker of the wrist-wearable device 110, the head-wearable device 120, and/or another communicatively coupled device to communicate with the user 105.

The AI agent 115 receives, at least, the second environmental data and determines, based on the second environmental data, a context-based user request and an AI response for responding to the context-based user request. For example, as shown in FIG. 1B, the AI agent 115 determines, based on the second environmental data, a context-based user request for taking notes and determines that an AI response for the context-based user request is AI-generated notes. The AI agent 115 can inform the user 105 of the context-based user request and the AI response (e.g., proactively assisting the user 105 in taking notes).

The AI agent 115 can determine a variety of context-based user requests and AI responses for responding to the context-based user requests. For example, a context-based user request can be assistance in learning to play a musical instrument, and the AI response can be musical instructions. In another example, a context-based user request can be assistance capturing images of loved ones, and the AI response can be the capture and storage of moments (image data associated with capture rules set by the user 105). In yet another example, a context-based user request can be assistance shopping, and the AI response can be tracking a shopping list. In a further example, a context-based user request can be auto-capturing image data and the AI response can be automatically capturing image data via the wearable device and/or another communicatively coupled device. In yet a further example, a context-based user request can be an information request, and the AI response can be identification of information related to the context-based user request (e.g., gathering information from additional sources, such as web searches, external databases, etc.). In an even further example, a context-based user request can be a summary request, and the AI response can be an AI-generated summary. The above examples are non-limiting, and any number of context-based user requests and AI responses for responding to the context-based user requests can be determined. Additional examples of the context-based user requests and AI responses for responding to the context-based user requests are provided below in reference to FIGS. 1C-14.

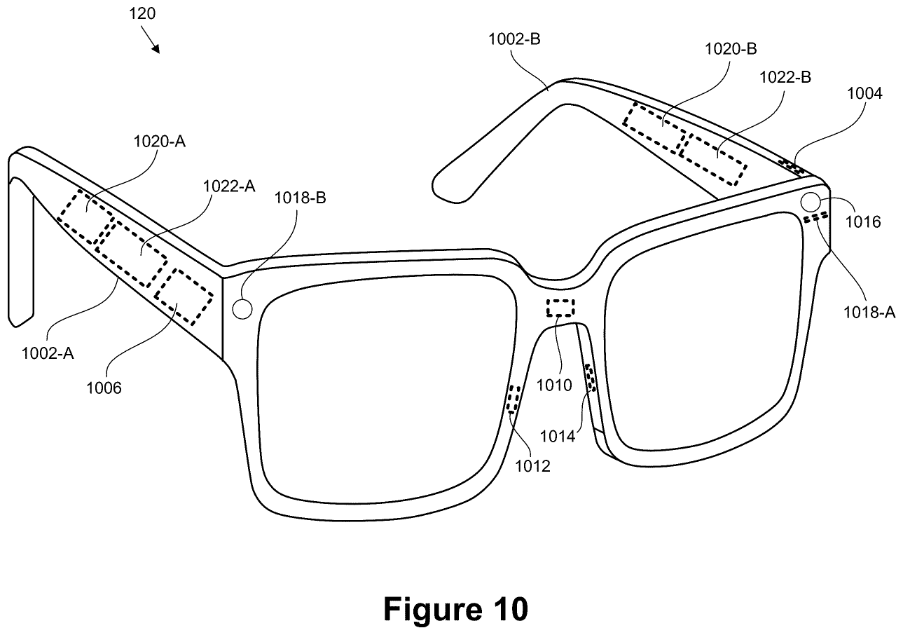

In some embodiments, a wearable device, such as the head-wearable device 120, includes a primary processor and a secondary processor. In some embodiments, a determination that the first environmental data satisfies the AI agent invocation trigger is made by the secondary processor, and a determination of the context-based user request and the AI response is made by, at least, a primary processor. One or more processors of the head-wearable device 120 are shown and described below in reference to FIG. 10.

In FIG. 1C, the AI agent 115 generates the AI response using, at least, the second environmental data. For example, the AI agent 115 uses audio data and/or image data of the second environmental data to transcribe and record the class or lecture. In some embodiments, the AI agent 115 generates a plurality of AI responses for responding to the context-based user requests. For example, in addition to the class recording and transcription, the AI agent 115 generates AI-generated notes to supplement the class recording and transcription. The AI response can identify people of interest, objects of interest, and/or other key information. For example, the AI response can include information on different speakers, such as a professor 136 and/or other students.

In some embodiments, the AI agent 115 notifies the user 105 of the AI responses being generated. For example, the AI agent 115 can present at the display of the head-wearable device 120, the wrist-wearable device 110, and/or another communicatively coupled device a user interface element indicating the operations performed by the AI agent (e.g., second UI element 134).

FIG. 1C further shows a field of view 150 of the user 105 as seen through the head-wearable device 120. The field of view 150 includes information presented via a display of the head-wearable device 120. The head-wearable device 120 can present one or more user interface elements 152 indicating the status of the head-wearable device 120, active components, and/or operations. For example, the one or more user interface elements 152 shown in FIG. 1C notify the user that the head-wearable device 120 is active and/or capturing image data (e.g., glasses symbols) and audio data (e.g., microphone symbol), current battery life (e.g., battery symbol), recording data (e.g., recording symbol), and AI agent activity (e.g., AI agent symbol).

The AI agent 115 can further present, at the wearable device, the AI response. For example, as further shown in the field of view 150, the head-wearable device 120 presents the AI-generated notes 154. The AI-generated notes 154 can be presented at a respective user interface element. The AI-generated notes 154 include information on the whiteboard 132 as well as a transcription of the professor 136's words.

In FIG. 1D, the AI agent 115 uses the second environmental data to determine subsequent context-based user requests and a corresponding AI response for responding to the subsequent context-based user requests. For example, the AI agent 115 uses audio and/or video data captured by the head-wearable device 120 and/or another communicatively coupled device to determine that the class or lecture is over and determine a subsequent context-based user request for creating a summary, as well as determining an AI response for generating an AI-generated summary. As described above, the AI agent 115 can present audio and/or visual feedback to the user 105 informing the user 105 of the operations of the AI agent 115 (e.g., a third user interface element 156 informing the user 105 that a summary will be generated).

The AI agent 115 further presents, at the wearable device, the AI response. For example, as further shown in the field of view 150, the head-wearable device 120 presents the AI-generated summary 158. The AI-generated summary 158 can be presented at a respective user interface element. The AI-generated summary 158 includes information on the whiteboard 132, a transcription of the professor 136's and/or students'words, action items, and/or supplemental information for augmenting the AI-generated notes 154. In other words, the AI agent 115 can further provide contextual information, such as definitions, links to webpages with similar topics, additional images, etc. to the AI-generated summary and/or notes to supplement the user 105's own notes.

In FIG. 1E, the user 105 is discussing with their classmate 107 after class. The AI agent 115, after providing the AI-generated summary 158, deactivates. After the AI agent deactivates, the AI invocation system 100 uses the wearable devices and/or other communicatively coupled devices to capture first environmental data. The AI invocation system 100 uses the first environmental data to determine when to invoke the AI agent 115 a subsequent time. In FIG. 1E, the AI invocation system 100 uses the conversation between the user 105 and the classmate 107 to determine whether the AI agent invocation trigger is satisfied. For example, the AI invocation system 100 can determine, based on the first environmental data, a transcript of an environment of the user 105 (e.g., the conversation between the user 105 and the classmate 107), and, in accordance with a determination that the transcript of the environment of the user 105 includes at least one predefined keyword of one or more predefined keywords of an AI agent invocation trigger, provides an indication that the first environmental data satisfies the AI agent invocation trigger. In other words, the AI invocation system 100 uses the conversation between the user 105 and the classmate 107 to invoke the AI agent 115.

As described above, after the AI agent 115 is invoked, the AI invocation system 100 causes the wearable devices and/or other communicatively coupled devices to capture second environmental data. The AI agent 115 uses the second environmental data to determine another context-based user request and another AI response for responding to the other context-based user request. As shown in field of view 160, the AI agent 115 determines the other context-based user request to create a reminder, and the AI response for responding to the other context-based user request is the generation of a reminder (e.g., calendar reminder UI element 166).

Additionally, the AI agent 115 uses the second environmental data to determine an additional context-based user request and an additional AI response for responding to the additional context-based user request. In particular, the AI agent 115 determines a context-based user request for providing additional information on a topic (e.g., a request for information) and an AI response for providing the additional information. For example, as shown in field of view 160, the AI agent 115 generates an AI response providing the user with information on a topic of conversation between the user 105 and the classmate 107 (e.g., fourth user interface element 164 providing information on a topic of conversation).

### Synchronization of AI-Generated Content

FIGS. 2A and 2B illustrate artificial intelligence notes generated by an artificial intelligence agent of a wearable device, in accordance with some embodiments. FIG. 2A shows a wrist-wearable device 110, including an AI agent for generating notes. In some embodiments, a user can invoke the AI agent via a touch input at the wrist-wearable device 110. For example, as shown in FIG. 2A, a user can select via a display 202 a use interface element for taking notes (e.g., note-taking user interface element 204). Alternatively, or in addition, in some embodiments, a user can perform one or more hand gestures and/or voice commands for selecting the note-taking user interface element 204. As described above in reference to FIGS. 1A-1E, the AI agent can use environmental data to generate the AI notes. The environmental data can be captured via the wrist-wearable device 110, a head-wearable device 120 (FIGS. 1A-1E), and/or one or more communicatively coupled devices (e.g., an ecosystem of devices can assist in taking notes for a wearer during an event, such as a meeting, a lecture, a presentation, etc.). By generating notes using the AI agent, a user can stay engaged with the event instead of focusing on taking notes.

The notes generated by the AI agent can be shared with one or more companion devices. For example, the AI agent shares generated notes with one or more electronic devices associated with the wrist-wearable device 110, such as a mobile device (e.g., a tablet 210). In some embodiments, the AI-generated notes are periodically synchronized. The AI-generated notes can be synchronized via one or more companion applications. In some embodiments, the AI-generated notes can be shared with one or more communicatively coupled devices. For example, the AI-generated notes can be shared with participants in a work meeting. In some embodiments, the AI-generated notes are augmented by companion applications and/or further detail can be added from web-based sources (e.g., online encyclopedias, articles, news sites, etc.).

The AI-generated notes can include image data (e.g., photo 212) captured by one or more communicatively coupled devices, a summary of an event (e.g., recap 214), and/or action items 216. The AI-generated notes can identify one or more participants of an event and associate each participant to relevant portions of the AI-generated notes. For example, as shown via action items 216, different action items are associated with respective participants. In some embodiments, the AI-generated notes can associate one or more participants with quotes, ideas, and/or other relevant information.

FIG. 2B shows synchronization of the AI-generated notes across communicatively coupled devices. FIG. 2B shows an example ecosystem in which the AI agent 115 can provide information beyond what is displayed at a head-wearable device 120 and/or a wrist-wearable device 110. For example, one or more applications included on a mobile device, such as the tablet 210 and/or computer 220, can support information-rich outputs, and the AI agent can provide requested information to the communicatively coupled mobile devices to provide the information-rich outputs (e.g., timestamps for captured audio and/or image data, web sources, hyperlinks, etc.). Alternatively, or in addition, the AI agent can silently and/or as a background process provide information to communicatively coupled devices.

### Invocation of an AI Agent in Response to User Input at a Wearable Device

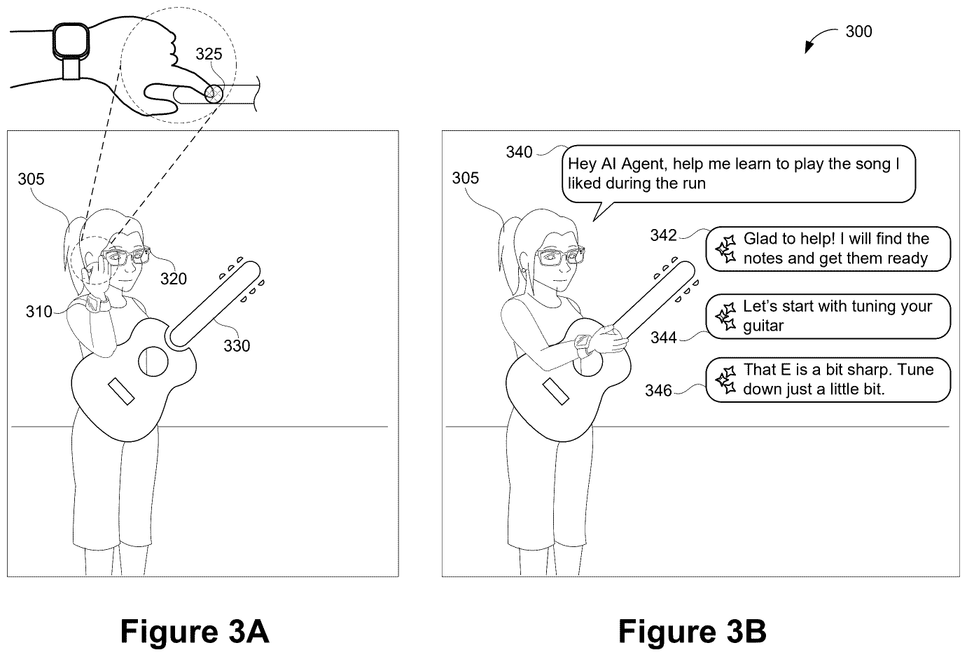

FIGS. 3A and 3B show invocation of the artificial intelligence agent using a touch input, in accordance with some embodiments. FIGS. 3A and 3B show another AI invocation system 300. The other AI invocation system 300 is analogous to, and/or part of, the AI invocation system 100 described above in reference to FIGS. 1A-1E. The other AI invocation system 300 includes at least a head-wearable device 320 (analogous to head-wearable device 120), a wrist-wearable device 310 (analogous to wrist-wearable device 110), and/or any other device of an XR system described below in reference to FIGS. 15A-15C-2.

In FIG. 3A, a user 305 donning the head-wearable device 320 and the wrist-wearable device 310 performs a touch input 325 at the head-wearable device 320 to invoke the AI agent 115. In particular, the user 305 performs the touch input 325 at the head-wearable device 320 to provide a request to the AI agent 115 as shown in FIG. 3B.

In FIG. 3B, the user 305 requests that AI agent 115 assist her in learning to play a song that the user 305 previously heard (e.g., voice command 340). The AI agent 115 can use data previously captured by one or more devices of the other AI invocation system 300 to identify the song mentioned by the user 305. Additionally, the AI agent 115 can use second environmental data captured by at least the wearable devices to determine a context-based request to learn to play a song on the guitar 330 and an AI response for providing musical instructions. The AI agent 115 generates the AI response and presents the response to the user 305 via a wearable device. For example, as shown in FIG. 3B, the AI agent 115 presents via a display of the head-wearable device 320 and/or a speaker of the head-wearable device 320 different instructions generated by the AI agent 115 (represented by instructions 342, 344, and 346). The AI responses generated by the AI agent 115 can be updated based on additional second environmental data. For example, the AI agent 115 can use audio data captured while the user 305 plays the guitar to determine what adjustments the user 305 should make.

As shown in FIGS. 3A and 3B, the AI agent 115 can use a plurality of sensors located at the head-wearable device 320 (e.g., microphones and outward cameras) and/or other communicatively coupled devices to determine if the user is playing the instrument correctly. In some embodiments, the AI agent 115 is configured to determine pitch and recognize variations of the user's song from the actual source song. In some embodiments, the AI agent 115 can also use cameras to determine if the user is playing the instrument correctly. For example, the AI agent 115 may notice incorrect finger placement on the chords of a guitar 330 or selecting the wrong key on a piano. While a guitar 330 is shown in FIGS. 3A and 3B, any skill with a learning curve can be interchanged, e.g., sport techniques, cooking techniques, etc.

In some embodiments, the AI agent 115 remains active as long as the user 305 engages in the activity. In accordance with a determination that the user ceases to perform in the activity, the AI agent deactivates. For example, if the user 305 ceases to practice playing the guitar 330, the AI agent 115 deactivates.

### Invocation of an AI Agent Based on Image Data And/or Eye-tracking Data

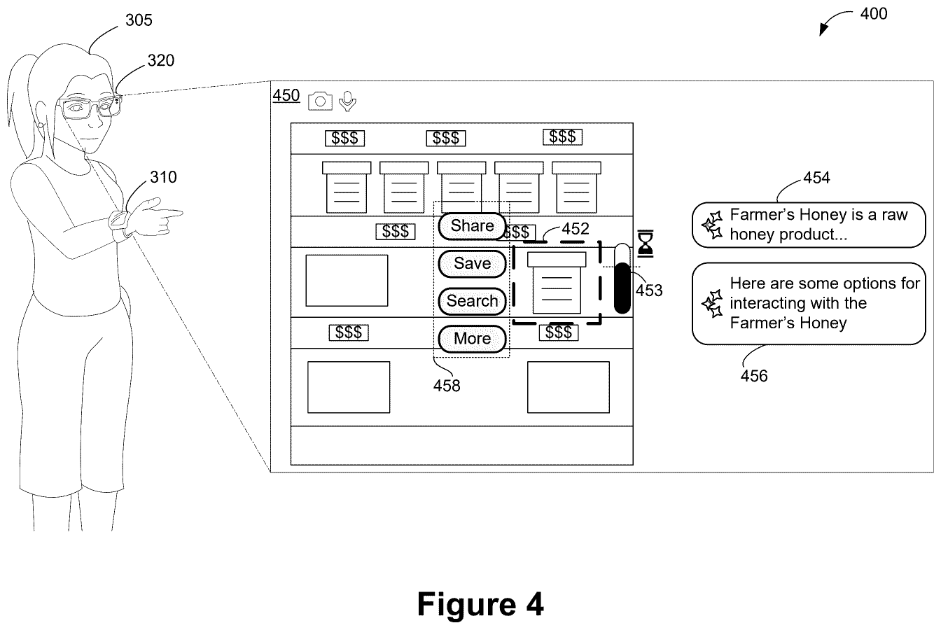

FIG. 4 illustrates additional invocations of an artificial intelligence agent, in accordance with some embodiments. FIG. 4 shows yet another AI invocation system 400. The AI invocation system 400 is analogous to, and/or part of, the AI invocation system 100 described above in reference to FIGS. 1A-1E. The AI invocation system 400 includes at least a head-wearable device 320 (analogous to head-wearable device 120), a wrist-wearable device 310 (analogous to wrist-wearable device 110), and/or any other device of an XR system described below in reference to FIGS. 15A-15C-2.

In some embodiments, the first environmental data captured by a wearable device, such as a head-wearable device 320, includes eye-tracking data, and the AI agent invocation trigger includes a predefined gaze-dwell time. The AI invocation system 400, in accordance with a determination that the eye-tracking data indicates that a gaze of the user satisfies the predefined gaze-dwell time, provides an indication that the first environmental data satisfies the AI agent invocation trigger. For example, as shown in field of view 450, a dwell timer 453 shows how long the user 305 has focused on an object of interest (e.g., product 452) and the broken line representing the predefined gaze-dwell time. In some embodiments, the dwell timer 453 is optional (e.g., not visible to the user 305).

Alternatively, or in addition, in some embodiments, the AI agent invocation trigger includes one or more predefined objects of interest, and the AI invocation system 400 identifies one or more objects of interest represented within the first environmental data. The AI invocation system 400, in accordance with a determination that at least one object of interest represented within the first environmental data is one of the one or more predefined objects of interest, provides an indication that the first environmental data satisfies the AI agent invocation trigger, which invokes the AI agent 115. In some embodiments, identifying the one or more objects of interest represented within the first environmental data includes determining, using a machine learning model, a classification for each object represented within the first environmental data, and identifying, based on the respective classifications of the objects represented within the first environmental data, the one or more objects of interest represented within the first environmental data. For example, as shown in FIG. 4, the product 452 can be identified as an object of interest and cause invocation of the AI agent 115.

As described above in reference to FIGS. 1A-1E, the AI agent 115 can determine, using second environmental data, context-based user requests and corresponding AI responses. For example, the AI agent can determine that the context-based user request is a request for additional information on the object of interest, and can determine an AI response for providing additional information on the object of interest. The AI agent 115 can generate and present the AI response to the user 305. For example, as shown in field of view 450, the head-wearable device 320 presents to the user 305, via a speaker or a display, a first AI-generated response 454 and a second AI-generated response 456.

Alternatively, or in addition, the AI agent 115 can determine, using the second environmental data, an additional context-based user request and a corresponding additional AI response. For example, the AI agent can determine that the context-based user request is a request for one or more AI actions corresponding to the object of interest and can determine an AI response for providing AI actions. The AI agent 115 can generate and present the AI response to the user 305. For example, as shown in field of view 450, the head-wearable device 320 presents to the user 305, via a speaker or a display, one or more AI actions 458, each AI action represented in a respective user interface element.

### Invocation of an AI Agent for Generation of Quick AI Responses

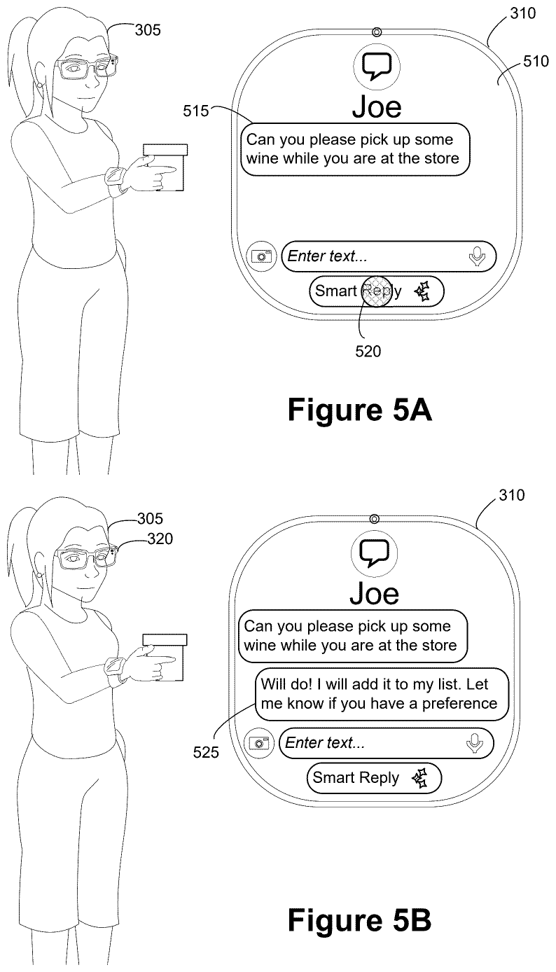

FIGS. 5A and 5B illustrate use of an artificial intelligence agent for generating responses, in accordance with some embodiments. FIGS. 5A and 5B illustrate a display 510 of a wrist-wearable device 310. The display 510 of the wrist-wearable device 310 presents a messaging user interface and/or one or more messages between the user and another contact. For example, the messaging user interface includes a message 515 from a contact. In some embodiments, the user 305 can use the AI agent 115 to generate a smart reply. For example, as shown in FIG. 5A, the user 305 provides a touch input 520 at the wrist-wearable device 310 to generate a smart reply using the AI agent 115. In some embodiments, in response to receiving the message 515, an AI invocation system (e.g., any AI invocation system described above in reference to FIGS. 1A-4) causes a wearable device to capture second environmental data. For example, the AI invocation system can cause a head-wearable device 320 to begin recording imaging data and/or audio data.

Turning to FIG. 5B, the AI agent 115 generates an AI response for responding to the message 515. The AI agent 115 can generate an automated reply 525 based on second environmental data and/or other information available to the AI agent 115. The second environmental data can be used by the AI agent 115 to determine information about one or more objects within the field of view of the user 305 and generate an AI response responsive to the message 515 and/or a user request. For example, the AI agent 115 can use captured image data to detect that the user 305 is shopping or at the grocery store and generate an automated reply 525 based on the image data. In some embodiments, the automated reply 525 is a draft at a message-composition user interface.

### Invocation of an AI Agent in Response to Voice Commands

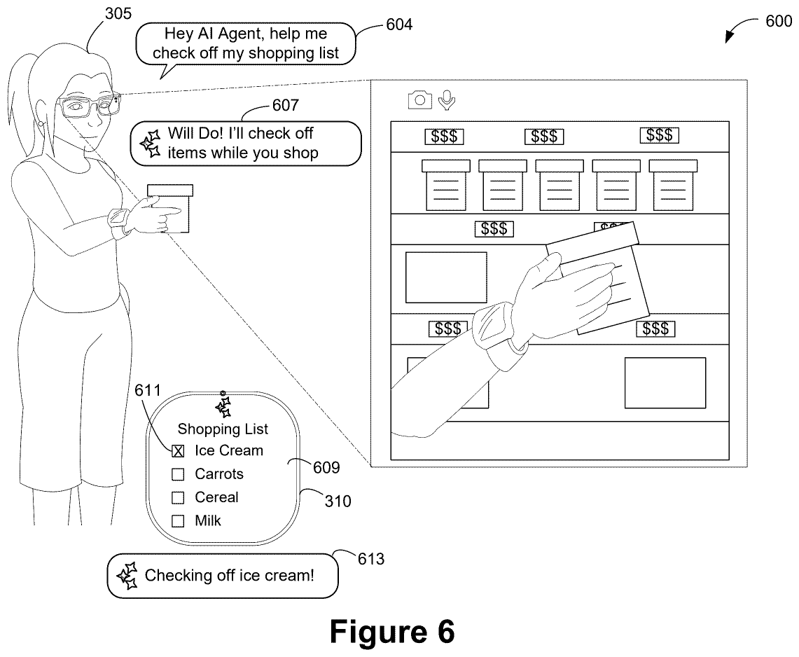

FIG. 6 illustrates an additional invocation of an artificial intelligence agent, in accordance with some embodiments. The additional AI invocation system 600 is part of, or is analogous to, the AI invocation system 100 described above in reference to FIGS. 1A-1E. The additional AI invocation system 600 includes at least a head-wearable device 320 (analogous to head-wearable device 120), a wrist-wearable device 310 (analogous to wrist-wearable device 110), and/or any other device of an XR system described below in reference to FIGS. 15A-15C-2.

FIG. 6 shows another example context-based user request and corresponding AI response. For example, the AI agent 115 can determine that the context-based user request is a request for assistance shopping, and the corresponding AI response can provide ongoing assistance shopping. As shown in FIG. 6, responsive to the request for assistance shopping 604, the AI agent 115 can automatically check items off a shopping list. For example, as the user 305 adds items to their physical shopping cart, the AI agent 115 can identify each item in the cart and associate it with an item on the checklist. In some embodiments, the AI agent 115 can generate a checklist by reviewing incoming text messages and/or voice messages. In some embodiments, the list can be auto-prepared and presented based on the user entering the location associated with the list. In some embodiments, the AI responses can be presented at the head-wearable device 320, the wrist-wearable device 310, and/or any other communicatively coupled device. For example, the AI response can be presented to the user 305 at the head-wearable device 320 via audio and/or visual feedback as shown by AI responses 607 and 613. Similarly, the wrist-wearable device 310 can present, via its display, a shopping list 609 and items checked off 611 by the AI agent 115.

In some embodiments, the user 305 interacts with an AI assistant that is providing the user information about objects with the user's field of view that are also noted in data stored at the head-worn device 320 or another connected device. For example, the head-worn device 320 may include a data object (e.g., a shopping list) that includes a set of items that the user 305 has added manually (e.g., through a set of voice commands, a text editor, a food tacking application, image data from a recipe book, etc.). In accordance with imaging devices of the head-wearable device 320 capturing image data of the user's field of view while the user is in a grocery store, the head-wearable device 320 provides respective indications to the user that items in the user's field of view correspond to the objects on the other list that the user created manually. In other words, the AI agent 115 described herein may be capable of using recently-stored data by the user at a different application in conjunction with image data captured by the head-wearable device 320 to proactively provide the user 305 with relevant insights based on the objects identified by the captured image data.

While a shopping list is described, any task in which a list can be completed is also something with which the AI agent 115 can assist (e.g., visiting different locations on a hike, seeing different things at a museum, running errands on the weekend, etc.).

### Reactive Invocation of an AI Agent

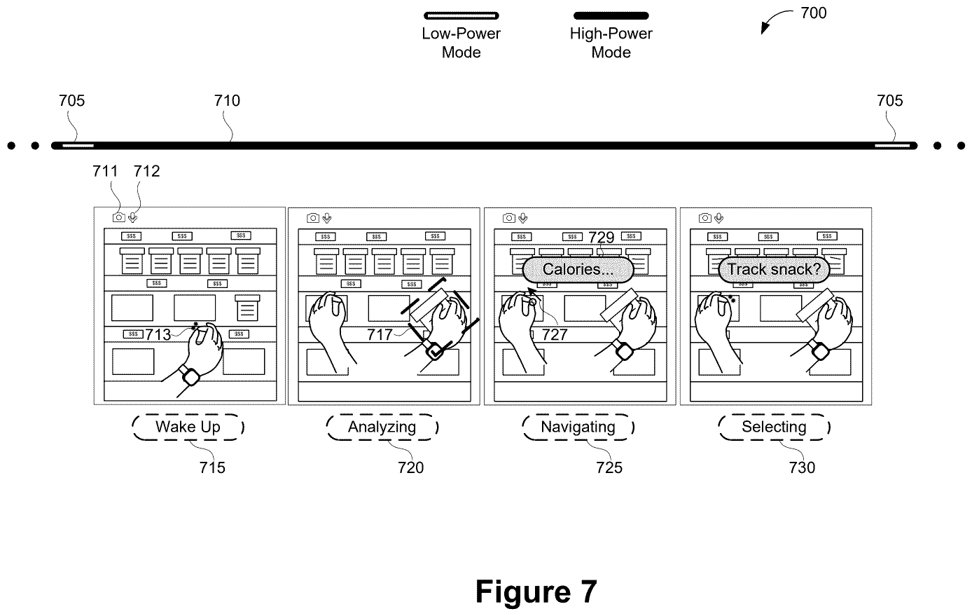

FIG. 7 illustrates an example of a reactive mode for activating the AI agent, in accordance with some embodiments. A reactive AI invocation system 700 includes a reactive mode for activating an AI agent 115. The reactive mode for activating the AI agent 115 is configured to conserve battery power of a wearable device, such as a head-wearable device 120, by activating the wearable device and/or invoking the AI agent 115 in response to a user input. The reactive AI invocation system 700 is part of, or is analogous to, the AI invocation system 100 described above in reference to FIGS. 1A-1E. The reactive AI invocation system 700 is configured to invoke the AI agent 115 in response to an input from a user.

At a first point in time, the wearable device starts in a low-power mode 705. When a user provides an input, such as a hand gesture (e.g., pinch gestures 713), a voice command, or a touch input, the wearable device transitions from the low-power mode 705 to a high-power mode 710 (e.g., wearable device activating; represented by waking-up status 715). In some embodiments, the input can be detected at the wearable device and/or using intermittent environmental data captured by a wearable device. For example, a head-wearable device 120 (FIGS. 1A-1E), while in the low-power mode 705, can capture intermittent environmental data that is used to detect hand gestures in image data. The head-wearable device 120 can capture at least image data and audio data via an imaging device and/or a microphone (represented by camera and microphone indicators 711 and 712). Alternatively, or in addition, in some embodiments, inputs are detected by other communicatively coupled devices. For example, hand gestures can be detected by one or more sensors (e.g., EMG or biopotential sensors) a worn wrist-wearable device. By using the user input to invoke the AI agent, the reactive AI invocation system 700 conserves battery power by utilizing the high-power mode 710 only when needed to perform operations of the AI agent.

At a second point in time, the wearable device is active and continuously captures environmental data. The reactive AI invocation system 700 detects, based on the environmental data, an object of interest (e.g., a product held by the user). In some embodiments, the AI agent 115 can display a bounding box 717 over the object of interest. The AI agent 115 can analyze (e.g., analyzing status 720) the object of interest based on the environmental data captured by the wearable device. For example, image data and/or audio data captured by the head-wearable device 120 can be used by the AI agent to identify an object of interest (e.g., identify the product), provide additional information about the object of interest, and/or present AI actions associated with the object of interest.

At a third point in time, the AI agent presents via the wearable device one or more AI actions based on the object of interest. For example, the head-wearable device 120 presents a user interface element (e.g., a calories user interface element 729) that when selected causes the head-wearable device 120 to present calorie information. Alternatively, the user can provide one or more inputs for navigating and/or scrolling through different AI actions (e.g., navigating status 725). For example, the user performs swipe gestures 727 to navigate through different AI actions.

At a fourth point in time, the reactive AI invocation system 700 detects user selection of an AI action (e.g., selection status 730). For example, the use performs another pinch gesture to select the track snack user interface element and track the object of interest (e.g., a snack that the user will eat). The reactive AI invocation system 700, after detecting selection of the AI action, causes the AI agent to perform any outstanding tasks before transitioning the wearable device back to the low-power mode 705. For example, the reactive AI invocation system 700, after detecting selection of the track snack user interface element, causes the AI agent 115 to create a record of the snack and transitions the head-wearable device 120 to the low-power mode 705.

### Proactive Invocation of an AI Agent

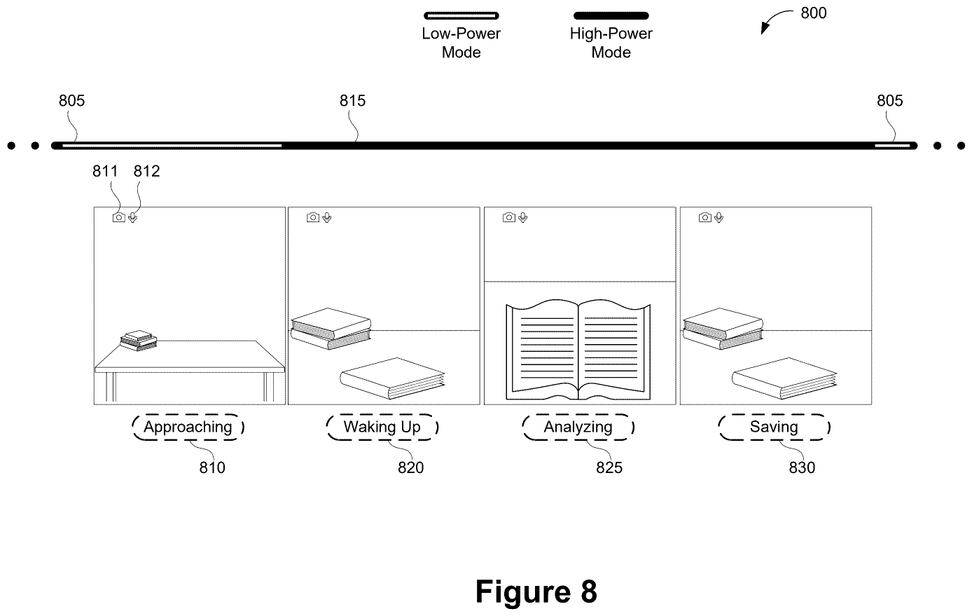

FIG. 8 illustrates an example of a proactive mode for activating the AI agent, in accordance with some embodiments. A proactive AI invocation system 800 includes a proactive mode for activating an AI agent 115. The proactive mode for activating the AI agent 115 is configured to conserve battery power of a wearable device, such as a head-wearable device 120, by activating the wearable device and/or invoking the AI agent 115 when environmental conditions (excluding user inputs) are met. The proactive AI invocation system 800 is part of, or is analogous to the AI invocation system 100 described above in reference to FIGS. 1A-1E. As discussed below, the proactive AI invocation system 800 is configured to automatically, without explicit input from a user, invoke the AI agent 115 for assisting the user.

At a first point in time, the wearable device starts in a low-power mode 805 and a user donning the wearable device approaches a desk. While the user approaches the desk (e.g., represented by approaching status 810), the wearable device intermittently captures environmental data. For example, a head-wearable device 120 (FIGS. 1A-1E) captures at least image data and audio data via an imaging device and/or a microphone (represented by camera and microphone indicators 811 and 812). To conserve battery of the wearable device (and while the wearable device is in the low-power mode 805), the wearable device captures the environmental data intermittently. The proactive AI invocation system 800 uses the captured environmental data to determine when to activate the AI agent and/or transition the wearable device to the high-power mode 815.

At a second point in time, the proactive AI invocation system 800 detects, based on the environmental data, an object of interest (e.g., a book) for the user, and transitions the wearable device to the high-power mode 815. For example, the proactive AI invocation system 800 can identify the one or more objects of interest represented within the first environmental data, determine that a distance between the wearable device and an object represented within the first environmental data is reduced by a non-zero rate, and identify the object represented within the first environmental data as an object of interest. The proactive AI invocation system 800, in response to detecting the object of interest, transitions the head-wearable device 120 to the high-power mode 815, waking up (e.g., waking-up status 820) the head-wearable device 120. The wearable device, while in the high-power mode, continuously captures environmental data.

At a third point in time, the AI agent is provided the continuously captured environmental data to analyze the object of interest. In other words, the proactive AI invocation system 800 keeps the AI agent 115 active to assist the user with their task and/or augment an experience. For example, while a head-wearable device 120 captures image data of a book within a field of view of the user, the AI agent analyzes text of the book (e.g., analyzing status 825).

At a fourth point in time, the proactive AI invocation system 800 detects that the object of interest has been deprioritized (e.g., book was closed and put down). The proactive AI invocation system 800, after detecting that the object of interest has been deprioritized, causes the AI agent to perform any outstanding tasks before transitioning the wearable device back to the low-power mode 805. For example, the proactive AI invocation system 800, after detecting, based on the environmental data, that the user closed the book they were reading, transitions the head-wearable device 120 to the low-power mode 805 after the AI agent 115 finishes saving (e.g., saving status 830) the environmental data associated with the user reading the book. In some embodiments, the AI agent determines if the information is worth categorizing and/or storing in memory (e.g., determines whether the information satisfies relevance criteria). In some embodiments, the AI agent generates a summary of the book, based on the captured environmental data, and saves the summary for the user. In some embodiments, once the AI agent identifies an aspect of the object in the physical surroundings, it can be configured to identify additional data about the object of interest (e.g., from an online resource or other external database). The AI agent can generate the summary using a large language model (LLM). The summary can be generated in accordance with any of FIGS. 1A-2B.

### Example Configuration AI Agent Invocation Triggers, Context-based User Request, and AI Responses

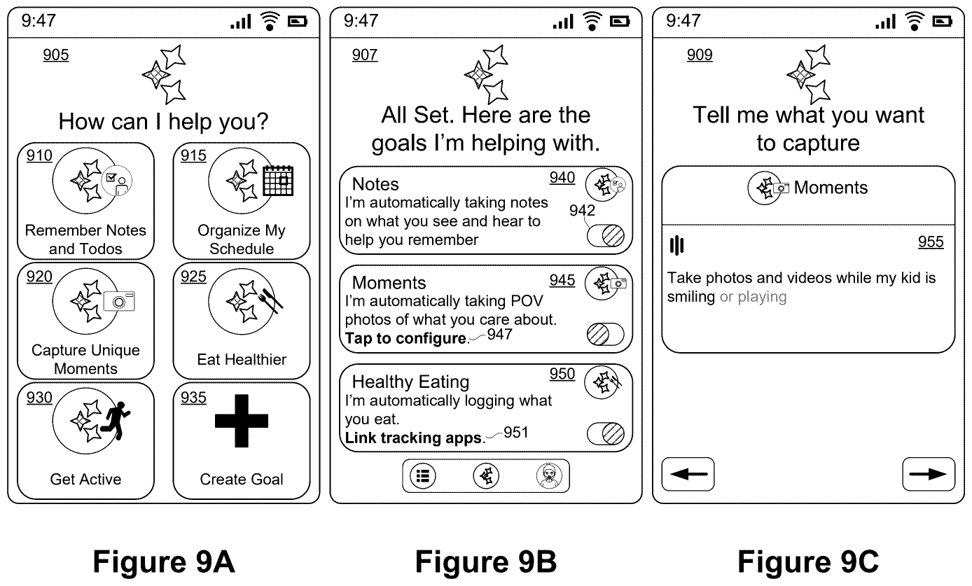

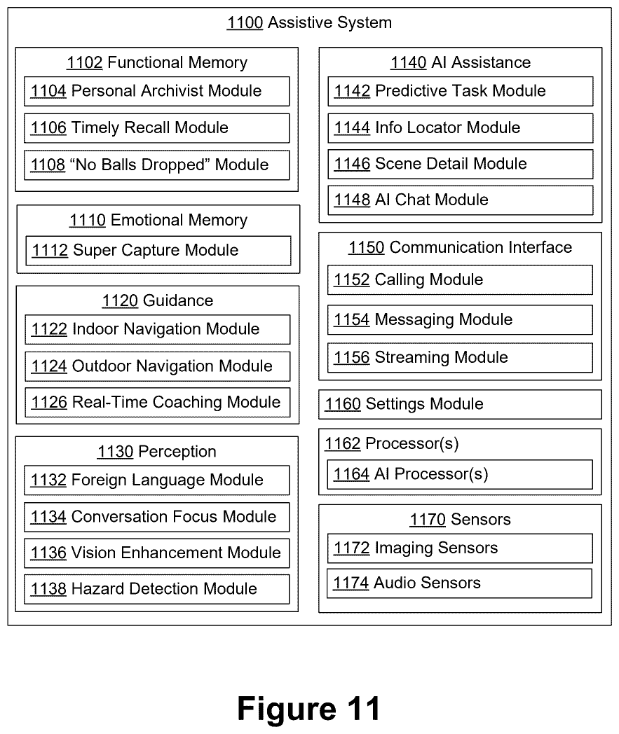

FIGS. 9A-9C illustrate user interfaces for modifying and/or defining objectives of AI invocation systems and/or assistive systems, in accordance with some embodiments. The user interfaces can be used with any AI invocation system described above in reference to FIGS. 1A-8, as well as the assistive system 1100 described below in reference to FIG. 11. The different user interfaces shown in FIG. 9A can be presented at a wearable device, such as a wrist-wearable device 110, a head-wearable device 120, and/or any other devices of XR systems described below in reference to FIGS. 15A-15C-2.

FIG. 9A shows a first user interface 905 for configuring one or more context-based requests, relevance criteria, and/or archiving criteria. For example, the first user interface 905 includes a first user interface element 910 for configuring AI-generated notes and/or AI-managed to-do lists, a second user interface element 915 for configuring AI-managed schedules and organization tools, a third user interface element 920 for configuring AI capture of image data, a fourth user interface element 925 for configuring AI-managed meal logs and/or hydration trackers, a fifth user interface element 930 for configuring AI-managed exercise logs, and a sixth user interface element 935 for customizing additional context-based request and associated rules.

FIG. 9B shows a second user interface 907 for reviewing configurations of context-based requests and/or toggling activation of the context-based requests. For example, the second user interface 907 includes a notes user interface element 940 identifying AI-note taking rules (e.g., “I'm automatically taking notes on what you see and hear to help you remember”), a moments user interface element 945 identifying AI image data capture rules (e.g., “I'm automatically taking POV photos of what you care about”), and a healthy eating user interface element 950 identifying meal tracking rules for the AI agent (e.g., “I'm automatically logging what you eat”). Each respective user interface element can include a toggle user interface element 942 for enabling or disabling respective context-based requests. In some embodiments, the second user interface 907 includes one or more additional user interface elements for configuring a context-based request (e.g., configure user interface element 947) and linking one or more applications (e.g., application linking user interface element 951).

FIG. 9C shows a third user interface 909 for configuring context-based requests. For example, a configuration input field 955 can be used to define one or more rules or criteria for a context-based request. As shown in the third user interface 909, the rules or criteria for a moments context-based request are being defined (e.g., “Take photos and videos while my kid is smiling or playing”).

### Example Head-Wearable Device

FIG. 10 illustrates a head-worn device 120 and/or 320 for use with embodiments described herein. In some embodiments, the head-worn device 120 and/or 320 includes some or all of the components of the AR device 1528. The head-worn device includes two temple arms 1002-A and 1002-B that each comprise electronic components, in accordance with some embodiments. In some embodiments, the head-worn device 120 includes a plurality of different processors, including a first processor 1004 comprising a power management integrated circuit (PMIC) and Wi-Fi capabilities, and a second processor 1006, different from the first processor, which may be a co-processor, in accordance with some embodiments. That is, in some embodiments, the second processor 1006 is configured to assist the processor 1004 by receiving off-loaded computing capabilities from the co-processor. In accordance with some embodiments, the head-worn device 120 includes a third integrated circuit 1010 that is configured as a power management integrated circuit specifically for charging the electronic components of the head-worn device 120.

In some embodiments, the electronic components of the head-worn device 120 include a contact microphone 1012, which may be configured to assist in eye-tracking. In some embodiments, the head-worn device 120 includes an eye-tracking module 1014 for tracking eyes of the user of the head-worn device 120. In some embodiments, the head-worn device 120 includes a plurality of different cameras, including a 12-megapixel CAI camera 1016, which may be front facing to capture images corresponding to a field of view of the user. In some embodiments, the head-worn device 120 includes a first downward facing CV camera 1018-A, and a front-facing CV camera 1018-B, which can be configured to capture image data for use in object reconstruction and validation.

In some embodiments, the head-worn device 120 includes a first speaker 1020-A on the right temple 1002-A and a second speaker 1020-B on the left temple 1002-B. In some embodiments, the speakers are configured to provide audio messages produced by an AI module stored in memory of the head-worn device 120. In some embodiments, the head-worn device includes a first removable battery 1022-A in the right temple arm 1002-A and a second removable battery 1022-B in the left temple arm 1002-A.

In some embodiments, the head-worn device includes a SLAM sensor that is persistently monitoring eye-tracking, hand-tracking, and/or object/scene/motion detection at the head-worn device 120. In some embodiments, at least one of the CV cameras 1018-A and 1018-B and the contact microphone 1012 remain persistently activated in conjunction with the SLAM sensor for assisting in one or more of the functions described above with respect to the SLAM sensor. Such “always-on” functionality of the head-worn device makes it configurable for a range of tasks that will be described in more detail below.

### Example AI Invocation System Architectures

FIG. 11 shows a block diagram illustrating components of an example assistive system 1100, in accordance with some embodiments. One of skill in the art will recognize that the list of use cases described by FIG. 11 is not exhaustive, and that the head-worn device 120 may be capable of many other uses not described herein. One of skill in the art will also appreciate that the assistive system 1100 may be implemented at a computing device that does not include some or all of the components of the head-worn device 120 (e.g., FIGS. 1A-10). The assistive system 1100 is analogous to AI invocation systems described above in reference to FIGS. 1A-9C.

In some embodiments, the core use cases of the head-worn device 120 include auto-capturing of photos and videos and the capabilities of storing and indexing functional memories, by using AI-assisted techniques. That is, in some embodiments, the head-worn device is configured to auto-capture photos and/or videos by using AI to automatically recognize memorable moments (e.g., when a baby is smiling, a cute moment playing with a dog, a particularly beautiful landscape). In some embodiments, the head-worn device allows the user to easily capture functional memories like reminders, notes, calendar entries, and more (in some cases automatically, in other cases with easy discrete watchband-less gestures).

In some embodiments, one or more trust, privacy, and/or data integrity modules can be incorporated into the assistive systems described herein in order to automatically integrate safety and compliance features into performance of the assistive systems.

In some embodiments, the head-worn device 120 includes a functional memory component 1102 that is capable of providing functional memory to the user, which can be relevant to a first set of use cases (e.g., personal archivist, timely recall, no balls dropped). In some embodiments, the AI assistant is able to observe facts about what the user is seeing and/or hearing. For example, the AI assistant may document conversations, books read, websites visited, people met, to-dos, meeting notes and action items, etc. In some embodiments, the AI assistant is capable of providing reminders about the obtained content to the user at the right moment.

In accordance with some embodiments, the functional memory component 1102 of the assistive system 1100 includes a personal archivist module 1104 that is configured to automatically capture, categorize, and/or store images and other data based on the real-world surroundings of the user. For example, in some embodiments, the head-worn device is configured to capture images and/or videos without the user providing a user input. For example, the imaging sensors may detect that the user is near a landmark (e.g., a vista along a trail) that satisfies automatic image-capture criteria. In response to detecting the proximity to the landmark and/or the satisfying of the automatic image-capture criteria, the AI assistant may cause an image to be captured by one or more cameras of the head-worn device or imaging sensors of an electronic device in communication with the head-worn device. In some embodiments, the AI assistant provides a notification to the user indicating that the image has been captured at the head-worn device.

In accordance with some embodiments, the functional memory component 1102 of the assistive system 1100 includes a timely recall module 1106 configured to proactively provide information that is relevant to the user based on the user's current context. For example, in some embodiments, the head-worn device is configured to enable an AI component of the assistive system 1100 (e.g., a predictive task module 1142, an information locator module 1144) to provide relevant facts to the user at appropriate moments for receiving the information (e.g., a timely recall module). For example, in some embodiments, the assistive system may be prompted to assist a user while the user is conducting a meeting or some other performance in front of other people. Based on context data about the user's performance, the assistive system may determine that data previously captured at the head-wearable device is relevant to the user's performance. And, in accordance with determining that the information is relevant to the user's current performance of the activity, the assistive system may provide feedback to the user (e.g., audio feedback, a visual user interface element, etc.) related to the relevant information that was previously captured by the head-wearable device. For example, the assistive system may provide the user with information about names of people you meet in real life, flight, gate, and/or seat information for an upcoming flight, and/or relevant data about a presentation that a user is performing or otherwise participating in.

In accordance with some embodiments, the assistive system 1100 includes a “no balls dropped” module 1108 that is configured to provide proactive assistance to a user of the head-worn device 120 in order to further the user's progress in completing one or more goals or furthering one or more predefined objectives recognized by the assistive system 1100. For example, in some embodiments, the assistive system 1100 is capable of inferring one or more goals or objectives of a user based on an activity that the user is performing, and the assistive system can proactively provide the user with information that will further their progress in completing the goal or objective. For example, the assistive system can remember items that a user was planning to get for dinner while determining that context information indicates that the user is currently at the grocery store and the assistive system can remind a user to pack a suitcase for a trip and/or to remember a bag for the gym.

In some embodiments, the assistive system includes an emotional memory component 1110 that is capable of providing emotional memory, which can be relevant to a second set of use cases (e.g., super capture). That is, in some embodiments, the head-worn device is configured to use an assistive system (e.g., one or more AI models) to automatically capture meaningful moments based on prompts provided by the user (e.g., take videos of special moments with my kid).

In some embodiments, the emotional memory component 1110 of the assistive system 1100 includes a super capture module 1112, which may be configured to enhance capturing of imaging data and/or audio data associated with memories of the user. For example, in some embodiments, a user can provide an open-ended prompt to the assistive system (e.g., “take nice pictures of my dog”). In accordance with providing the prompt to the assistive system, an AI component of the assistive system can cause images to be captured of the user's real-world surroundings that include context relevant to the prompt (e.g., a dog of the user). In some embodiments, the assistive system provides the user with an indication (e.g., a persistently displayed icon) indicating that the assistive system is capturing image data of the user's surroundings. In some embodiments, while the assistive system is performing a set of assistive operations corresponding to the user's prompt, the assistive system can provide content to the user (e.g., images, video, audio) corresponding to the user's prompt, which the user can review and/or modify at the head-wearable device. In some embodiments, an image-quality threshold is applied to the respective images captured by the assistive system to determine if the images should be saved in memory of the head-wearable device. In some embodiments, the head-wearable device provides AI assistive systems that assist the user to automatically capture images and videos during meaningful moments. For example, moments with pets, activities with kids, parties, trips with friends, sports, etc.

In some embodiments, the assistive system includes a guidance component 1120 that is capable of providing guidance information to the user (e.g., while they are navigating an area in their real-world surroundings). In some embodiments, the head-worn device 120 is capable of providing indoor and/or outdoor navigation (e.g., using an indoor navigation module 1122 and/or an outdoor navigation module 1124). For example, one or more AI models in electronic communication with the head-worn device may provide precise indoor and outdoor directions to the user. In some embodiments, the navigational features include turn-by-turn assistance.

In some embodiments, the head-worn device 120 is capable of providing real-time coaching to the user (e.g., using a real-time coaching module 1126). That is, one or more AI models in electronic communication with the head-worn device 120 may guide the user through a task with precise, timely feedback (e.g., while cooking a meal, drawing a picture, performing a repair (e.g., a vehicle repair), performing an exercise).

In some embodiments, the assistive system includes a perception component 1130 that is configured to provide enhancements to the user's perception of activities happening in the user's real-world environment (e.g., understanding other languages using a foreign language module 1132, focusing on a conversation to provide intuitive responses using a conversation focus module 1134, providing additional visual enhancement to a user's view of their real-world surroundings using a vision enhancement module 1136, and/or helping the user to avoid hazards using a hazard detection module 1138). That is, in some embodiments, the head-worn device can use one or more AI models to enhance the user's ability to hear and/or see in real time. For example, the head-worn device may help the user hear better, help the user to translate speech (e.g., by another person with a non-native language or accent, identifying a hazard that the user may not otherwise see, etc.).

In some embodiments, the assistive system 1100 includes an AI assistance component 1140 that is configured to utilize AI to provide details to a user based on providing data about the user's real-world surroundings to one or more AI models. For example, the AI assistance component 1140 can include a predictive task module 1142 for using context data about a user's real-world surroundings to predict a task or portion of a task that the assistive system 1100 can perform to enhance the user's performance of an activity; the AI assistance component 1140 can include an information locator module 1144 for locating relevant information based on an activity the user is performing or context data about the user's performance of the activity; the AI assistance component 1140 can include a scene detail module 1146 for providing information to the user about the scene in the user's physical surroundings, and/or an aspect (e.g., an object) within the physical surroundings; and the AI assistance component 1148 can include an AI chat module 1148 that is configured to initialize an AI-assisted conversation with the user.

In some embodiments, the assistive system 1100 and/or the head-worn device 120 can include a communication interface 1150, which may include, for example, a calling module 1152, a messaging module 1154, and/or a streaming module 1156. In some embodiments, the assistive system 1100 includes a settings module 1160, which may be used to store settings related to a set of objectives that the user would like the assistive system 1100 to use to determine intervention aspects.

In some embodiments, the assistive system 1100 includes one or more processors 1162, including one or more AI processors 1164, which may be specifically configured to perform assistive tasks at the head-worn device 120.

The assistive system 1100 includes one or more sensors 1170, which may be used in conjunction with one or more of the assistive tasks described herein. For example, the assistive system 1100 can include one or more imaging sensors 1172, which may be configured to capture images and/or videos while the user is performing an activity that utilizes the assistive system, and the assistive system can include one or more audio sensors 1174, which may be configured to receive voice commands from the user for activating components and/or modules of the assistive system, and/or obtaining data about the user's surroundings to be used in conjunction with operations of the components and/or modules.

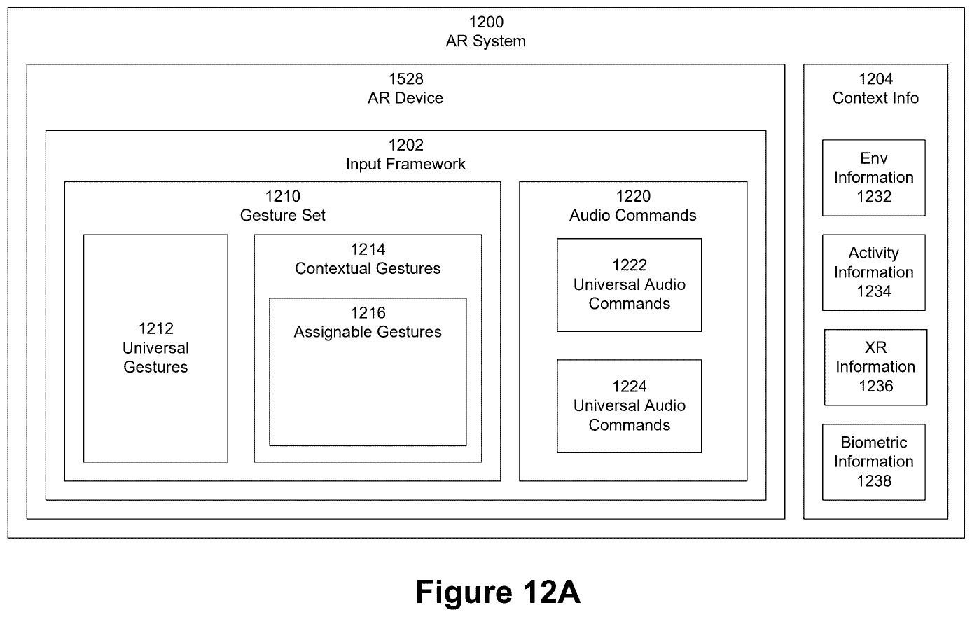

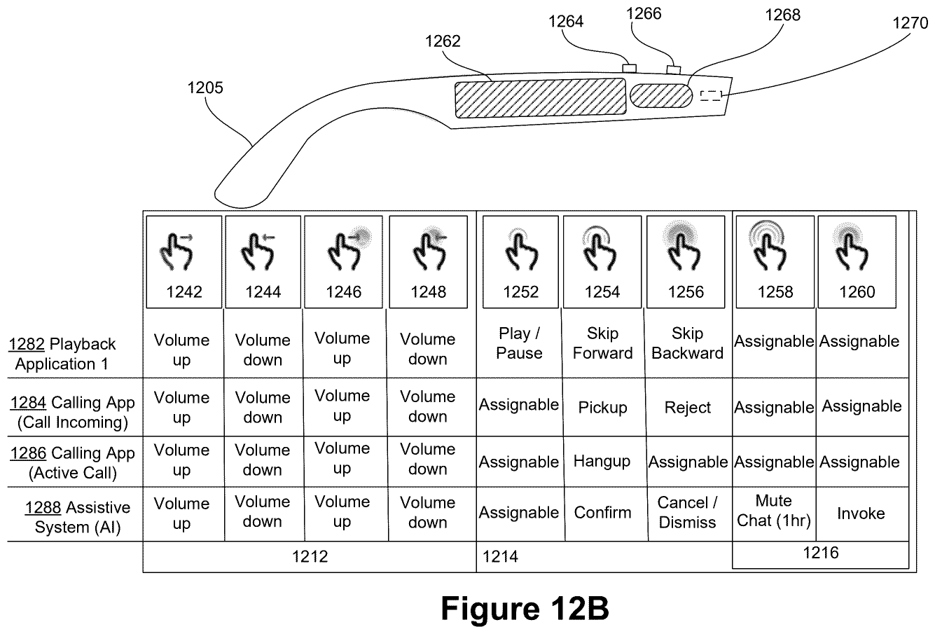

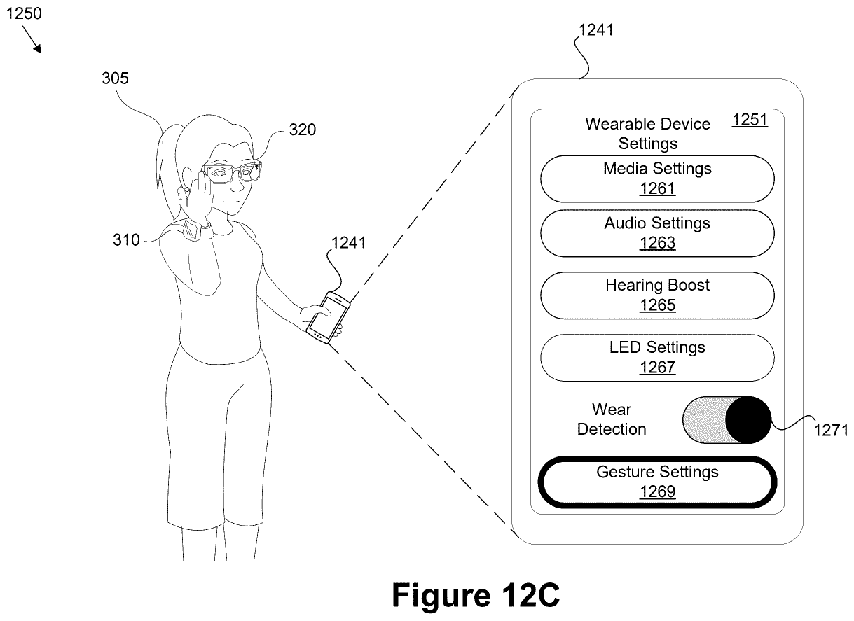

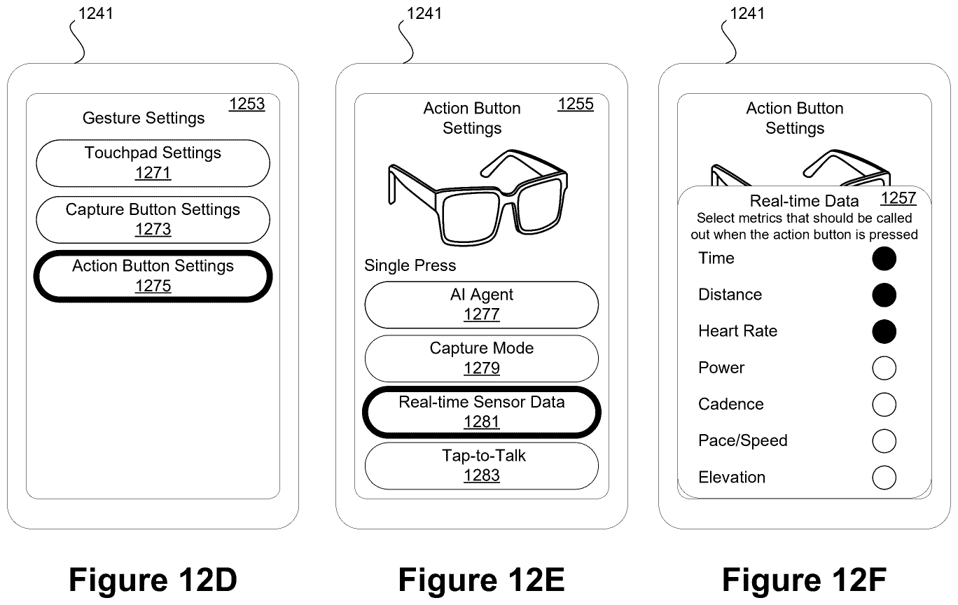

FIGS. 12A and 12B illustrate block diagrams of example input frameworks for interacting with affordances of a head-worn device, in accordance with some embodiments. For ease of description, the input frameworks in FIGS. 12A and 12B will be described with respect to the AR system 1200, including the AR device 1528. The AR system 1200 can be analogous to, or part of, the XR systems described below in reference to FIGS. 15A-15C-2.

FIG. 12A shows a first block diagram illustrating components of the input framework 1202. In accordance with some embodiments, the input framework 1202 includes a gesture set 1210, including user inputs corresponding to gestures performed by a user of a head-worn device (e.g., the AR device 1528 and/or MR device 1532; FIGS. 15A-15C-2). In some embodiments, the gesture set 1210 includes a first subset of gestures, including one or more universal gestures 1212, where respective gestures of the one or more universal gestures 1212 are reserved specifically for certain actions. In some embodiments, the one or more universal gestures 1212 are unique to the gesture set and cannot be re-assigned to a different respective gesture configuration. In some embodiments, each of the respective universal gestures correspond to unique operations. In some embodiments, the unique operations corresponding to the respective universal gestures of the one or more universal gestures 1212 cannot be re-mapped to any other respective gestures of the gesture set 1210.

In accordance with some embodiments, the gesture set 1210 includes a second subset of gestures comprising a plurality of contextual gestures 1214, different from the plurality of universal gestures 1212, where each respective contextual gesture of the contextual gestures 1214 are flexibly mapped to a plurality of different actions based on contextual information 1204 of the wearer (e.g., the user 105) while the user input is being performed. For example, the information about the context of the wearer may include a physical activity that the wearer is performing (e.g., running, riding a bike). In some embodiments, information about the context of the wearer may include information about another electronic device associated with the user that is in electronic communication with the AR device 1528.

In some embodiments, the contextual information 1204 includes environmental information 1232 about physical surroundings of the user 105. In some embodiments, the contextual information 1204 includes activity information 1234 about an activity that the wearer of the AR device 1528 is performing. In some embodiments, the contextual information 1204 includes extended-reality (XR) information 1236. For example, the XR information 1236 may include information about artificial-reality content (e.g., virtual objects) being presented to the user (e.g., via the AR device 1528). In some embodiments, the contextual information 1204 includes biometric information 1238, which may be obtained by one or more sensors of the AR device 1528 and/or one or more sensors of other devices in electronic communication with the AR device 1528.

FIG. 12B illustrates a temple arm 1205 of the AR device 1528, in accordance with some embodiments. In some embodiments, the temple arm 1205 includes a plurality of input affordances for receiving user inputs from a wearer of the AR device 1528. For example, the temple arm 1205 can include a capacitive touch affordance 1262 and/or a capacitive touch button 1268.

In some embodiments, there is a predefined subset of universal gestures 1212 that the user can perform at the head-worn device. For example, the gestures corresponding to the subset of universal gestures 1212 can include a forward swipe gesture 1242, a backward swipe gesture 1244, a forward swipe and hold gesture 1246, and a backward swipe and hold gesture 1248. In accordance with some embodiments, each of the universal gestures 1212 corresponds to the same subset of operations regardless of the context of the performance of the user input (e.g., what application(s) are activated at the head-worn device, detection of an activity that the user is performing).

In some embodiments, there is a predefined subset of contextual gestures 1214 that can be configured to perform a more flexible subset of predictable actions based on the context (e.g., picking up an incoming call and skipping tracks during music play share the same gesture). For example, the predefined subset of contextual gestures can include a single tap gesture 1252, a double tap gesture 1254, a tap and long hold gesture 1256, a triple tap gesture 1258, and a tap and hold gesture 1260. In some embodiments, a subset of the contextual gestures 1214 are explicitly assignable gestures (e.g., the triple tap gesture 1258, the tap and hold gesture 1260), meaning they are user-defined shortcuts that can be set up in the settings of the head-worn device.

In some embodiments, each of the universal gestures 1212, contextual gestures 1214, and assignable gestures 1216 described above are to be performed at the capacitive touch affordance 1262. In some embodiments, there is a second capacitive touch affordance 1268, which may be exclusively used for activating an assistive system of the head-worn device (e.g., an artificial-intelligence-based assistive system).

In some embodiments, there are additional buttons on the temple arm 1205, such as the top peripheral buttons 1264 and 1266, and the inner button 1270 (e.g., tactile buttons). In some embodiments, one or more of the additional buttons on the temple arms can be used to perform operations directed to a power management interface of the head-worn device (e.g., turning the device on and off). In some embodiments, the additional buttons can also be used in conjunction with one or more of the capacitive touch affordances 1262 and 1268 in order to perform combinational operations at the head-worn device. For example, a first input directed to the capacitive touch sensor 1262 in parallel with the user pressing the top peripheral button 1264 may be used for troubleshooting the head-worn device.

Additional, non-limiting examples of input modes for engaging with assistive systems at a head-worn device are described below.

A first input mode for interacting with the head-worn devices including an integrated assistive system 1100 (FIG. 11) is described. The first input mode is a touch-first input mode requiring the user to provide a touch input to interact with the assistive system 1100. In accordance with some embodiments, a wake word cannot be utilized while the first input mode is activated at the head-worn device. In some embodiments, the touch-first input mode is the default mode. In some embodiments, the first input mode requires a touch input directed to the capacitive touch affordance 1262 described with respect to FIG. 12B.

In some embodiments, after the user provides the user input (e.g., directed to the capacitive touch affordance 1262), an assistive system 1100 is activated at the head-worn device (e.g., providing audio feedback via a speaker or an earcon). In some embodiments, after the earcon has been activated, the assistive system 1100 waits for a predefined amount of time (e.g., a wake timeout) to determine if the user has provided a voice command while the assistive system 1100 is activated. In some embodiments, if the user does not provide a voice command while the earcon is activated, the assistive system 1100 becomes inactive, meaning that it requires an additional touch input to re-activate. In some embodiments, if a voice command is provided within the predefined amount of time, the assistive system 1100 handles the voice command. In some embodiments, after the assistive system 1100 handles the voice command, the assistive system 1100 remains active for a predefined amount of time (e.g., the wake timeout or a different timeout period). In some embodiments, the first input mode is the lowest power usage input mode, but does not allow for the convenience of hands-free functionality.

A second input mode for interacting with a head-worn devices including an integrated assistive system 1100 is described. The second input mode requires a user input to wake the AI agent, but after doing so, is configured to provide hands-free mode for subsequent interactions with the AI agent until a timeout occurs. In some embodiments, after the user provides the initial input, in accordance with the user providing a voice command before the timeout, the assistive system 1100 provides a notification to the user that the hands-free mode has been enabled at the head-worn device. In some embodiments, if the user does not provide a voice command or other relevant user input after providing the touch input, the assistive system 1100 automatically returns to the touch-first input mode that requires the user to provide touch inputs in order to interact with the assistive system 1100.

A third input mode for interacting with a head-worn devices including an integrated assistive system 1100 is described. The third input mode is a hands-free input mode that allows the user to provide a voice command to activate the assistive system 1100. For example, the user may provide a voice command stating, “hey AI agent”; “ok AI agent”; and/or “hey <character name>”. In some embodiments, when the user provides a voice command with a specific character name corresponding to a personified AI agent that the user has previously interacted with, that specific AI agent is activated at the head-worn device (e.g., a celebrity voice for an AI agent). In some embodiments, the hands-free mode is only activated in accordance with determining that the head-worn device has a battery level above a low battery threshold.

A fourth input mode for interacting with a head-worn device including an integrated assistive system 1100 is described. The fourth input mode for interacting with the head-worn device is a conditional hands-free mode that is automatically turned off when a low-battery threshold is hit. For example, the user may provide a voice command as described with respect to third input mode, and in response to receiving the voice command, the assistive system 1100 may determine whether the low battery threshold has been hit at the head-worn device. If so, the assistive system 1100 may provide an audio message to the user indicating that the hands-free mode is disabled based on low battery at the head-worn device. In some embodiments, even if the low battery threshold has not been hit, the assistive system 1100 may be automatically turned off after a predefined amount of time in order to conserve battery at the head-worn device.

A fifth input mode for interacting with a head-worn device including an integrated assistive system 1100 is described. The fifth input mode allows the user to engage the assistive system 1100 without providing a predefined wake word. In other words, the user can provide a natural language voice command, and the assistive system 1100 can be configured to determine whether the user's voice command indicates that the user is attempting to engage in an AI-assisted hands-free session. In some embodiments, after the user has engaged the assistive system 1100, the user may provide a touch input to subdue the session. In some embodiments, the AI-assisted session can be automatically disabled in accordance with the assistive system 1100 obtaining data indicating that the user had begun to perform a different activity that does not involve voice interactions with the AI (e.g., initializing playback of media content, starting a call), or not providing a voice command for a predefined amount of time. In some embodiments, the assistive system 1100 is able to recognize and forgo storage of voice inputs detected by other people that are not the user of the head-worn device.

A sixth input mode for interacting with a head-worn device including an integrated assistive system 1100 is described. The sixth input mode allows the user to engage the assistive system 1100 in different ways based on whether they have used the assistive system 1100 within a predefined amount of time previously (e.g., within the last month). In some embodiments, if the user has not used the assistive system 1100 within the predefined amount of time, then the assistive system 1100 can provide the user with educational instructions for how to prompt and/or disable the assistive system 1100 in accordance with engaging it.

FIGS. 12D-12F illustrate example configuration user interfaces for adjusting operation of a wearable device, in accordance with some embodiments. In particular, FIGS. 12D-12F show a user 305 assigning one or more commands to one or more input affordances of a wearable device, such as a head-wearable device 320, via a wearable device configuration system 1250. The wearable device configuration system 1250 is analogous to, and/or part of, the AI invocation systems described above in reference to FIGS. 1A-11. The wearable device configuration system 1250 includes at least a head-wearable device 320 (analogous to head-wearable device 120), a wrist-wearable device 310 (analogous to wrist-wearable device 110), a mobile device 1241, and/or any other device of an XR system described below in reference to FIGS. 15A-15C-2.

In FIG. 12D, the user 305 donning the head-wearable device 320 and the wrist-wearable device 310 performs a user input to accesses the first configuration UI 1251. The user input can be a voice command, a hand gestures, a touch input, a device input, etc. For example, the user 305 can provide one or more user inputs at the head-wearable device 320, wrist-wearable device 310, the mobile device 1241, and/or any other device of an XR system to access the first configuration UI 1251. The first configuration UI 1251 can be presented at one or more of the head-wearable device 320, wrist-wearable device 310, the mobile device 1241, and/or any other device of an XR system. In some embodiments, the first configuration UI 1251 can be transferred between communicatively coupled devices. For example, the user 305 can provide a user input for accessing the first configuration UI 1251 via the head-wearable device 320 and cause the first configuration UI 1251 to be presented at the mobile device 1241 and/or any other communicatively coupled device.

The first configuration UI 1251 includes one or more configuration UI elements and/or one or more toggle UI elements for adjusting operation and/or activating or deactivating one or more functions of a wearable device. For example, the first configuration UI 1251 includes, at least, a media settings UI element 1261, an audio settings UI element 1263, a hearing boost setting UI element 1265, an LED setting UI element 1267, and a gesture setting UI element 1269 for adjusting operation of a wearable device, such as the head-wearable device 320. The first configuration UI 1251 can include a wear detection toggle UI element 1271 for activating and/or deactivating wear detection functionality of a wearable device (e.g., currently shown as active). In FIG. 12C, the user 305 provides a user input selecting the gesture setting UI element 1269 (denoted by a thick outline surrounding the gesture settings UI element 1269).

Turning to FIG. 1F, a second configuration UI 1253 is presented at the mobile device 1241. The second configuration UI 1253 is a gesture configuration UI that includes one or more input affordance configuration UI elements. For example, the second configuration UI 1253 includes a first input affordance configuration UI element 1271 for adjusting one or commands associated with a touch input affordance (e.g., touchpad affordance of a head-wearable device 320, such as the capacitive touch affordance 1262 and/or the capacitive touch button 1268), a second input affordance configuration UI element 1273 for adjusting one or commands associated with a capture-button affordance (e.g., the top peripheral buttons 1264 or 1266 of the head-wearable device 320), a third input affordance configuration UI element 1275 for adjusting one or commands associated with an action-button affordance (e.g., the top peripheral buttons 1264 or 1266 of the head-wearable device 320). The input affordance configuration UI elements shown in FIG. 12D are non-limiting and other input affordance configuration UI elements can be included. As further shown in FIG. 12D, the user 305 provides another user input selecting the third input affordance configuration UI element 1275 (denoted by a thick outline surrounding the third input affordance configuration UI element 1275).

In FIG. 12E, a third configuration UI 1255 (e.g. an action button configuration UI) is presented at mobile device 1241 in response to detecting the other user input selecting the third input affordance configuration UI element 1275 (e.g., a request to assign one or more commands to the action-button affordance). The third configuration UI 1255 includes one or more command UI elements representative of commands available at the wearable device. Non-limiting examples of the one or more command UI elements include an AI agent command UI element 1277, a capture mode command UI element 1279, a real-time sensor data command UI element 1281, a tap-to-talk command UI element 1283, media streaming (or playlist) command UI element (not shown), live translation command UI element (not shown), and visual assistance (e.g., be my eyes) command UI element (not shown). In some embodiments, one or more of the commands are predetermined commands (e.g., commands that cannot be customized or edited by the user 305). In some embodiments, the one or more of the commands are customizable by the user 305.

The user 305 can select a command UI element to assign a command to the action-button affordance and/or define one or more parameters of the command when a user input is provided at the action-button affordance. For example, as shown in FIG. 12E, the user 305 selects the real-time sensor data command UI element 1281 to assign a real-time data read out command to the action-button affordance such that, when the action-button affordance is pressed, real-time sensor data is read out to the user 305.

As described above, in some embodiments, selection of a command UI element can allow the user 305 to define one or more parameters of the command such that the command is assigned to a respective input affordance with the defined one or more parameters. For example, as shown in FIG. 12F, in response to user selection of the real-time sensor data command UI element 1281, another UI 1257 is presented to the user 305 for defining one or more metrics that should be read out to the user 305 when the action-button affordance is pressed (e.g., time, distance, and hear rate are selected by the user 305).

One or more parameters can be defined for each of the commands available at the wearable device. For example, in response to selection of the AI agent command UI element 1277, the user 305 can be presented with UI for defining one or more of silent invocation of the AI agent, initiation of a live AI session, and/or defining a custom AI prompt such that the specified action is performed when a user input is provided at a respective input affordance. In response to selection of the capture mode command UI element 1279, the user 305 can be presented with UI for defining one or more capture modes (e.g., Hyperlapse, Slo-Motion, Panorama, etc.), auto capture triggers (when auto capture is enabled via a user input at a respective input affordance), capture settings (e.g., brightness, frame rate, bit rate, etc.), and/or other capture settings such that an imaging device is initiated with the user defined parameters when a user input is provided at a respective input affordance. In response to selection of the tap-to-talk command UI element 1281, the user 305 can be presented with UI for defining one or more communication modes (e.g., “Tap-To-Talk” (Voice Message contact or group), mesh networks, etc.).

The wearable device configuration system 1250, in response to receiving one or more commands to be assigned to input affordances of the wearable device (e.g., via command selection UI elements, such as the AI agent command UI element 1277, the capture mode command UI element 1279, the real-time sensor data command UI element 1281, the tap-to-talk command UI element 1283, etc.), provides a control signal to the wearable device for associating the input affordance with user selected commands.

While the examples shown and described in reference to FIGS. 12C-12F assign a command to an action-button affordance of a head-wearable device 320, one or more commands can be assigned to different input affordances of the head-wearable device 320 and/or other wearable devices. For example, one or more user-defined commands can be assigned to the capacitive touch affordance 1262 and/or the capacitive touch button 1268 of the head-wearable device 320. Similarly, one or more user-defined commands can be assigned to one or more input affordances of the wrist-wearable device 310 (e.g., physical buttons, touch screen, etc.).

### Example Operations for Invoking an AI Agent

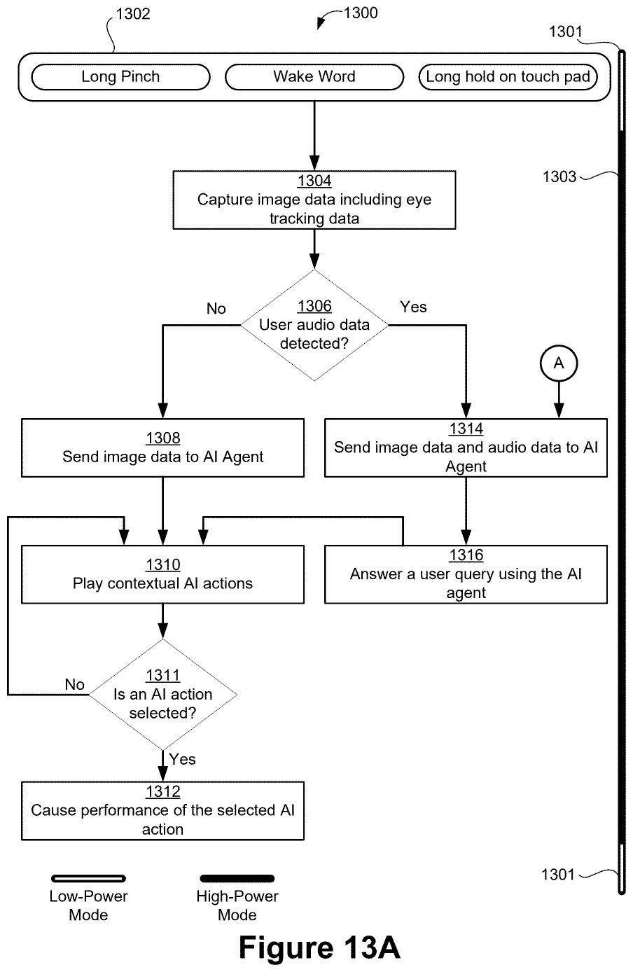

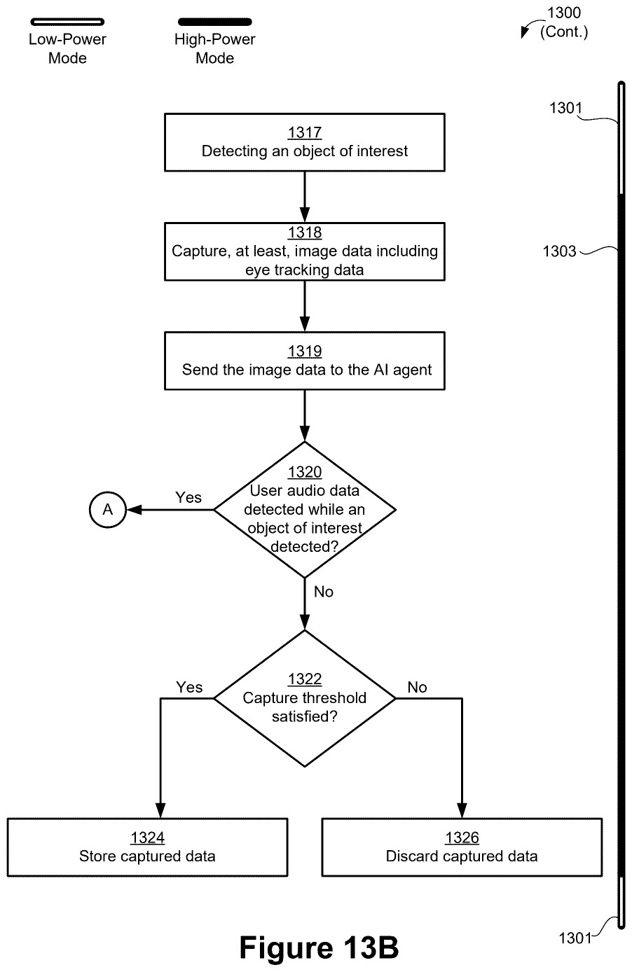

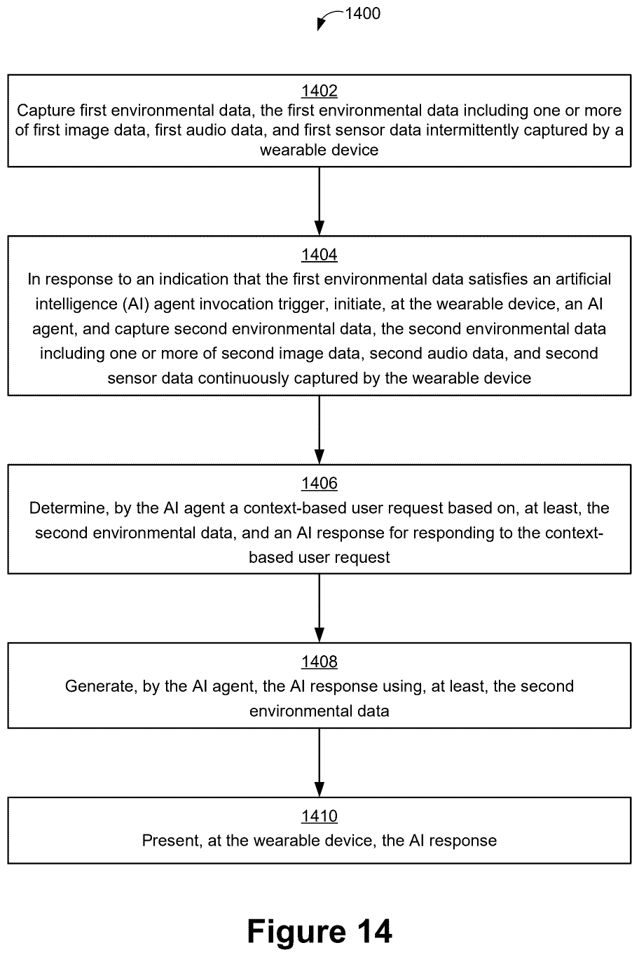

FIGS. 13A-14 illustrate diagrams of processes and methods of invoking an artificial intelligence agent at a wearable device, in accordance with some embodiments. Operations (e.g., steps) of FIGS. 13A-14 can be performed by one or more processors (e.g., a central processing unit and/or MCU) of a system (e.g., XR systems of FIGS. 15A-15C-2). At least some of the operations shown in FIGS. 13A-14 correspond to instructions stored in a computer memory or computer-readable storage medium (e.g., storage, RAM, and/or memory). Operations of the FIGS. 13A-14 can be performed by a single device alone or in conjunction with one or more processors and/or hardware components of another communicatively coupled device (e.g., a wrist-wearable device 110 and a head-wearable device 120) and/or instructions stored in memory or a computer-readable medium of the other device communicatively coupled to the system. In some embodiments, the various operations of the methods described herein are interchangeable and/or optional, and respective operations of the methods are performed by any of the aforementioned devices or systems or a combination of devices and/or systems. For convenience, the method operations will be described below as being performed by particular components or devices, but should not be construed as limiting the performance of the operation to the particular device in all embodiments.

FIGS. 13A and 13B illustrate logic diagrams illustrating reactive and proactive activation modes of an artificial intelligence agent, in accordance with some embodiments. For ease of reference, the reactive and proactive activation modes are referred to generally as activation mode 1300. FIG. 13A shows a reactive mode for activating the AI agent, and FIG. 13B show a proactive mode for activating the AI agent. While operating in the reactive mode, the wearable device (e.g., a head-wearable device 120; FIGS. 1A-10) can respond to a user input 1302 performed by a user, such as a long pinch, a wake word, a touch input at the wearable device (e.g., a long hold on a touch bar), etc. Alternatively, while operating in the proactive mode, the wearable device can activate the AI agent based on detection of an object of interest 1317 (e.g., detecting, based on environment data captured by the wearable device or other communicatively coupled devices, that the user is holding an object and/or pointing at an object).

Turning to FIG. 13A, the activation mode 1300 includes receiving (1302) a user input. Non-limiting examples of the user input includes hand gestures (e.g., detected finger contact gestures), voice commands, and touch inputs (e.g., user inputs at a surface of a wearable device). Before receiving (1302) the user input, the wearable device operates in a low-power mode 1301. When the user input is received, the wearable device transitions to a high-power mode 1303.

The activation mode 1300 includes capturing (1304), at least, image data, including eye tracking data. The activation mode 1300 determines (1306) whether user audio data is detected. The activation mode 1300, in accordance with a determination that user audio data is not detected (“No” at operation 1306), includes sending (1308) the image data to the AI agent. The activation mode 1300 also includes playing (1310) a contextual AI action. In other words, the AI agent presents contextual AI actions based on the image data for user selection. The activation mode 1300 further includes determining (1311) whether an AI action is selected by the user. User selection of an AI action can be performed via a user input, such as a hand gesture, a voice command, a touch input, image data, eye-tracking data, etc. The activation mode 1300, in accordance with a determination that an AI action is not selected (“No” at operation 1311), returns to operation 1310 and presents another AI action. For example, if a user performs a swipe gesture or does not select an AI action within a predetermined period of time, the activation mode 1300 presents another AI action. Alternatively, the activation mode 1300, in accordance with a determination that an AI action is selected (“Yes” at operation 1311), includes causing (1312) performance of the selected AI action. After causing performance of the selected AI action, the activation mode 1300 transitions the wearable device from the high-power mode 1303 to the low-power mode 1301.

Returning to operation 1306, the activation mode 1300, in accordance with a determination that user audio data is detected (“Yes” at operation 1306), includes sending (1314) the image data and the audio data to the AI agent. The activation mode 1300 includes answering (1316) a user query using the AI agent. In some embodiments, the AI agent provides one or more answers to the user query as options. The one or more answers to the user query are presented as contextual AI actions at operation 1310. An example of the reactive mode for activating the AI agent is provided and described above in reference to FIG. 7.

In FIG. 13B, the activation mode 1300 includes detecting (1317) an object of interest. The object of interest can be detected based on environmental data captured by a wearable device and/or a communicatively coupled device. In some embodiments, detection of the object of interest is based on user possession and/or highlighting of an object (e.g., the user holding or pointing to an object). Before detecting (1317) the object of interest, the wearable device operates in the low-power mode 1301. When the object of interest is detected, the wearable device transitions to the high-power mode 1303. The activation mode 1300 further includes capturing (1318), at least, image data, including eye tracking data, and sending (1319) the image data to the AI agent.

The activation mode 1300 further includes determining (1320) whether user audio data is detected while an object of interest detected. The activation mode 1300, in accordance with a determination that user audio data is detected while an object of interest detected (“Yes” at operation 1320), proceeds to operation 1314 of FIG. 13A. Alternatively, the activation mode 1300, in accordance with a determination that user audio data is not detected while an object of interest in detected (“No” at operation 1320), includes determining (1322) whether a capture threshold is satisfied. The activation mode 1300, in accordance with a determination that the capture threshold is satisfied (“Yes” at operation 1322), includes storing (1324) the captured data. Alternatively, the activation mode 1300, in accordance with a determination that the capture threshold is not satisfied (“No” at operation 1322), includes discarding (1326) the captured data. After causing performance of the selected AI action, the activation mode 1300 transitions the wearable device from the high-power mode 1303 to the low-power mode 1301. After performance of either operations 1324 or 1326, the activation mode 1300 transitions the wearable device from the high-power mode 1303 to the low-power mode 1301. An example of the proactive mode for activating the AI agent is provided and described above in reference to FIG. 8.

(A1) FIG. 14 shows a flow chart of a method 1400 of invoking an artificial intelligence agent at a wearable device, in accordance with some embodiments. The method 1400 occurs at a wearable device, such as a head-wearable device 120 (or AR device 1528 and/or MR device 1532), including one or more of a display, one or more imaging devices, one or more sensors, one or more microphones, and/or other components described below in reference to FIGS. 15A-15C-2. In some embodiments, the method 1400 includes capturing (1402) first environmental data. The first environmental data includes one or more of first image data, first audio data, and first sensor data intermittently captured by the wearable device. For example, as shown and described in reference to FIGS. 1A-13B, the wearable device and/or any other device communicatively coupled with an XR system can intermittently capture image data, audio data, sensor data, and/or any other data of a user's surroundings, and use the intermittently captured data to determine when to invoke the AI agent.

The method 1400 includes, in response to an indication that the first environmental data satisfies (1404) an AI agent invocation trigger, initiating, at the wearable device, an AI agent, and capturing second environmental data. The second environmental data includes one or more of second image data, second audio data, and second sensor data continuously captured by the wearable device. In other words, after the AI agent is invoked, one or more imaging devices, one or more sensors, one or microphones, and/or other components of the wearable device and/or any other device communicatively coupled with an XR system are activated or caused to continuously capture data that is used by the AI agent for fulfilling user requests. For example, as shown and described in reference to FIGS. 1A-13B, the wearable device and/or any other device communicatively coupled with an XR system can continuously capture image data, audio data, sensor data, and/or any other data of a user's surroundings, and provide the continuously captured data to the AI agent.

The method 1400 includes determining (1406) by the AI agent a context-based user request based on, at least, the second environmental data and an AI response for responding to the context-based user request. More specifically, the AI agent is provided the second environmental data to determine a type of user request that may be prompted by a user, as well as a response for fulfilling the user request that may be prompted by the user. Different examples of context-based user requests and AI responses are shown and described above in reference to FIGS. 1A-13B.

The method 1400 further includes generating (1408), by the AI agent, the AI response using, at least, the second environmental data and presenting (1410), at the wearable device, the AI response. The generated AI response can be audio feedback, visual feedback, haptic feedback, and/or a combination thereof. The AI response can be presented at the wearable device and/or any other device communicatively coupled with an XR system. In some embodiments, generated AI response is based on the capabilities of the available devices. For example, in accordance with a determination that a head-wearable device is a display-less device, the AI response generated by the AI agent may be audio and/or haptic feedback. Alternatively, in accordance with a determination that a head-wearable device includes at least a display, a speaker, and/or a haptic feedback response, the AI response generated by the AI agent may be audio feedback, visual feedback, and/or haptic feedback. Different examples of the presented AI responses are shown and described above in reference to FIGS. 1A-13B.

(A2) In some embodiments of A1, the first environmental data include location data, and the AI agent invocation trigger includes a location of interest. The method further includes, in accordance with a determination that the wearable device is within a predefined distance of the location of interest, providing an indication that the first environmental data satisfies the AI agent invocation trigger. For example, as shown and described in reference to FIGS. 1A-1E, when a user 105 enters the classroom, the AI agent 115 is invoked to assist the user 105.

(A3) In some embodiments of any one of A1-A2, the first environmental data include eye-tracking data, and the AI agent invocation trigger includes a predefined gaze-dwell time. The method further includes, in accordance with a determination that the eye-tracking data indicates that a gaze of the user satisfies the predefined gaze-dwell time, providing an indication that the first environmental data satisfies the AI agent invocation trigger. For example, as shown and described in reference to FIG. 4, when a predefined gaze-dwell threshold time is satisfied, the AI agent 115 is invoked to assist the user 305.

(A4) In some embodiments of any one of A1-A3, the AI agent invocation trigger includes one or more predefined keywords. The method further includes determining, based on the first environmental data, a transcript of an environment of a user and, in accordance with a determination that the transcript of the environment of the user includes at least one predefined keyword of the one or more predefined keywords, providing an indication that the first environmental data satisfies the AI agent invocation trigger. For example, as shown and described in reference to FIGS. 1E and 6, when one or more predefined keywords are detected (e.g., a request from the user and/or from other parties interacting with the user) (e.g., “Could you please share...” and “Hey AI agent...”), the AI agent 115 is invoked to assist the user.

(A5) In some embodiments of any one of A1-A4, the AI agent invocation trigger includes one or more predefined objects of interest. The method further includes identifying one or more objects of interest represented within the first environmental data and, in accordance with a determination that at least one object of interest represented within the first environmental data is one of the one or more predefined objects of interest, providing an indication that the first environmental data satisfies the AI agent invocation trigger. For example, as shown and described in reference to FIGS. 8-9C, when an object of interest is detected (e.g., a book or a smile of a child of a user), the AI agent 115 is invoked to assist the user.

(A6) In some embodiments of A5, identifying the one or more objects of interest represented within the first environmental data includes determining that a distance between the wearable device and an object represented within the first environmental data is reduced by a non-zero rate and identifying the object represented within the first environmental data as an object of interest. For example, as shown and described in reference to FIG. 8, when the user approaches an object of interest (e.g., the book), the AI agent 115 is invoked to assist the user.

(A7) In some embodiments of any one of A5-A6, identifying the one or more objects of interest represented within the first environmental data includes determining, using a machine learning model, a classification for each object represented within the first environmental data and identifying, based on the respective classifications of the objects represented within the first environmental data, the one or more objects of interest represented within the first environmental data. For example, the systems and methods disclosed herein can perform facial recognition to detect and/or identify a person, a speaker, a bystander, etc., as well as one or more facial features.

(A8) In some embodiments of any one of A1-A7, the context-based user request includes auto-capturing image data, and the AI response includes automatically capturing image data via the wearable device. For example, as shown and described in reference to FIGS. 9A-9C, the systems and methods disclosed herein can use the AI agent to automatically capture, at least, image data or “moments” for the user. The systems and methods disclosed herein can also be used to automatically capture notes, activities, meals, and/or other goals defined by the user.

(A9) In some embodiments of any one of A1-A8, the context-based user request includes a note-taking request, and the AI response includes AI-generated notes. For example, as shown and described in reference to FIGS. 1A-1E, the AI agent can detect when to capture notes and generate notes to assist the user.

(A10) In some embodiments of any one of A1-A9, the context-based user request includes an information request, and the AI response is identification of information related to the context-based user request. For example, as shown and described in reference to FIG. 1E, the AI agent can provide insight information (e.g., information on the binomial theorem) in response to the conversation of the user with another person.

(A11) In some embodiments of any one of A1-A10, the context-based user request includes a summary request, and the AI response is an AI-generated summary. For example, as shown and described in reference to 1D, the AI agent can generate and provide a summary based on an event and/or conclusion of the event.

(A12) In some embodiments of any one of A1-A11, a determination that the first environmental data satisfies the AI agent invocation trigger is made by a secondary processor, and a determination of the context-based user request and the AI response is made by, at least, a primary processor. By using a secondary processor, the systems and methods disclosed herein conserve battery power and improve thermal performance by using a more efficient and/or lightweight processor to process intermittent tasks.

(A13) In some embodiments of any one of A1-A11, the method further includes providing the first environmental data and/or the second environmental data to an LLM, detecting one or more sentences in the first environmental data and/or the second environmental data, and determining, for each end of sentence using the LLM, the context-based user request. In some embodiments, the method further includes proactively surfacing a respective AI response for fulfilling the context-based user request. In some embodiments, each end of sentence is provided to an LLM prompt.

(A14) In some embodiments of any one of A1-A13, the AI response is generated using an LLM, and the LLM-generated response is a visual response and/or audio response presented at the wearable device.

(A15) In some embodiments of any one of A1-A14, the context-based user request is an auto-capture trigger, and the AI response is the capture of environmental data in response to satisfaction of the auto-capture trigger. For example, image and/or audio data can be automatically captured during a meeting or other event (e.g., image and/or audio data can be automatically captured in response to detection of an argument during the meeting, identification of an action item identified during the meeting, identification of open action items, etc.). In some embodiments, the method further includes using the AI agent to filter out any image data and/or audio data that do not satisfy relevance criteria, discarding image data and/or audio data that do not satisfy relevance criteria, and/or storing image data and/or audio data that do satisfy relevance criteria.

(A16) In some embodiments of any one of A1-A15, the method includes receiving user input defining relevance criteria and archiving captured environmental data that satisfies the relevance criteria. For example, the method can include other customizations to personal archivist technology that can be used to specify which information should be archived.

(A17) In some embodiments of A16, the method includes receiving, via user input, a plurality of relevance criteria. First relevance criteria of the plurality of relevance criteria corresponding to context-based user requests (e.g., meetings, shopping assistance, requests for information, etc.), and second relevance criteria of the plurality of relevance criteria corresponding to situational events (e.g., events unrelated to a specific goal (e.g., meetings, shopping, etc.), such as small talk with another individual that relates to one of the user's user-driven goals).

(A18) In some embodiments of any one of A1-A17, the method includes identifying, based on the first and/or second environmental data, one or more speakers within the first and/or second environmental data (e.g., audio data) and associating each speaker with a respective visual representation in the AI response.

(A19) In some embodiments of any one of A1-A18, the method further includes, before sharing the AI response, personalizing the AI response content and format based on user preferences (e.g., user interest, which can be based on a customized configuration of their personal archivist settings). For example, as shown and described in reference to FIGS. 9A-9C, the user can define different data that is stored. For example, as shown and described in reference to FIGS. 1A-1E, the AI agent can identify different speakers and assign tasks and/or transcriptions to the respective speakers.

(A20) In some embodiments of any one of A1-A19, the method further includes transitioning the wearable device between different power modes based on one or more power-mode transition triggers. For example, the wearable device can transition between a low-power mode and a high-power mode based on one or more events represented in the first and/or second environmental data and/or user inputs. For example, FIGS. 7, 8, 13A, and 13B show and describe power-mode transition triggers.

(A21) In some embodiments of any one of A1-A20, the wearable device is one or more of a head-wearable device and a wrist-wearable device.

(B1) In accordance with some embodiments, a method includes obtaining an indication that a user of a head-wearable device is participating in an event that involves the sharing of information and, in accordance with obtaining the indication, causing (i) one or more imaging sensors and (ii) one or more microphones in electronic communication with the head-wearable device to begin persistently obtaining respective imaging and audio data. The method also includes providing the respective imaging and audio data to an AI model and receiving, based on the respective imaging and audio data provided to the AI model, one or more AI-generated data items from the AI model. The one or more AI-generated data items include one or more of a first respective data item, including a dictation and/or transcript of conversational content from the event, a second respective data item including a meeting summary of the event based on detected information shared at the event, a third respective data item including one or more images captured by the one or more imaging sensors in electronic communication with the head-wearable device, and a fourth respective data item including a set of items for the user to revisit after the event has concluded.

(B2) In some embodiments of B1, at least one of the one or more AI-generated data items is a composite data item that includes two or more different AI-generated data items of the one or more AI-generated data items.

(B3) In some embodiments of any one of B1-B2, the method also includes identifying, based on imaging and/or audio data being persistently obtained by the one or more cameras and the one or more microphones, that a person participating in the event is interacting with an object in proximity to the user and, in accordance with the identifying, causing imaging data to be obtained that includes time-sequenced imaging data of the object being interacted with by the person participating in the event.

(C1) In accordance with some embodiments, a method includes, while a user is wearing (i) a head-wearable device including one or more world-facing cameras configured to obtain image data corresponding to at least a portion of a field of view of a user and (ii) a wrist-wearable device including one or more neuromuscular-signal sensors configured to detect neuromuscular activations performed by a user, obtaining first neuromuscular data indicating performance of a first gesture performed by the user. The method also includes, in response to detecting the first gesture performed by the user, activating at least one camera of the one or more cameras to cause the at least one camera to begin collecting image data corresponding to the field of view of the user, obtaining second neuromuscular data indicating performance of a second hand gesture performed by the user. The method further includes, in response to detecting the second hand gesture performed by the user, identifying a real-world object within the field of view of the user based on the image data and the hand gesture, providing respective image data including the identified real-world object to an AI model, obtaining, from the AI model, information about the identified real-world object different than the information obtained via the image data from the one or more cameras, and presenting to the user the information about the identified real-world object that was obtained from the AI model.

(D1) In accordance with some embodiments, a method includes receiving an indication to persistently obtain image data about a user's surroundings using one or more cameras of a head-wearable device. The method includes, in accordance with receiving the indication, obtaining imaging data corresponding to a field of view of a user.

(D2) In some embodiments of D1, the indication to persistently obtain image data is based on a received electronic message.

(E1) In accordance with some embodiments, a method includes, at a head-wearable device having an associated input affordance for performing commands, receiving an indication from a user to assign a command to the physical input, wherein the command is configured to cause operations related to a contemporaneous interaction with an assistive AI agent.

(E2) In some embodiments of E1, the input affordance for performing commands is a physical button on a peripheral portion of the body of the head-wearable device.

(E3) In some embodiments of any one of E1-E2, the method includes, after receiving the indication from the user to assign the command to the physical input, causing an interaction with an assistive AI agent to be initiated during the interaction with the assistive AI agent, detecting the user performing a selection of the input affordance and, based on the selection of the input affordance, causing the assistive AI agent to be interrupted and activating one or more microphones of the head-wearable device for recording a message.

(E4) In some embodiments of any one of E1-E3, the method includes receiving an indication to monitor an aspect related to a physical activity that a user is performing and, in accordance with receiving the indication, providing a persistent indicator affordance within a peripheral portion of a field of view of the user during performance of the activity. The method also includes, responsive to a determination that (i) the monitored aspect related to the physical activity satisfies a monitored threshold, and/or (ii) the user has completed the physical activity, adjusting presentation of the persistent indicator affordance to reflect the determination.

(F1) In accordance with some embodiments, a method includes receiving a touch-based input at a pair of smart glasses to invoke an AI agent. The method includes, in response to invoking the AI agent, in accordance with a determination that the pair of smart glasses is receiving environment data of a first type, the AI agent providing a first output that is at least partially determined by the environment data of the first type and, in accordance with a determination that the pair of smart glasses is receiving environment data of a second type that is different from the environment data of the first type, the AI agent providing a second output that is at least partially determined by the environment data of the second type.

(G1) In accordance with some embodiments, a method includes receiving a request at an AI agent to (i) forgo immediate output of incoming notifications and (ii) provide a summary of the incoming notifications at a later time. The method includes receiving a plurality of notifications, providing the notifications to an LLM, and producing, using the LLM, a summary of the plurality of notifications. The method further includes providing a natural language summary, via an output modality of a head-wearable device, at the later time.

(H1) In accordance with some embodiments, a method includes, while a user is wearing a head-wearable device comprising one or more sensors for obtaining data about real-world surroundings of a user, receiving an instruction to initialize an assistive system at the head-wearable device. The one or more sensors include one or more imaging sensors for obtaining imaging data of the real-world surroundings of the user. The method includes, based on the received instruction, obtaining contextual information about the real-world surroundings of the user. The method includes determining, based on contextual information obtained after receiving the instruction, a set of assistive operations to perform at the head-wearable device in conjunction with the received instruction. The set of assistive operations are directed to one or more predefined objectives of the assistive system. The set of assistive operations include capturing image data about the real-world surroundings of the user.

(H2) In some embodiments of H1, the method further includes, based on determining the set of assistive operations to perform at the head-wearable device, determining whether to increase power consumption at the head-wearable device to facilitate performance of one or more respective operations of the set of assistive operations. For example, as described above in reference to, at least, FIGS. 7, 13A, and 13B, based on the user performing the initial pinch gesture, the systems and methods (e.g., an assistive system 1100) disclosed herein may determine to transition to a high-power mode for capturing image data and applying it to an AI model.

(H3) In some embodiments of H2, the determining whether to increase the power consumption at the head-wearable device is based on a determination that additional capture, editing, or effects are required with respect to capturing of the image data as part of performing the set of assistive operations. For example, in accordance with determining that the user is engaging with the super capture module 1112, the assistive system 1100 can cause additional imaging effects to be provided by the assistive system 1100.

(H4) In some embodiments of any one of H1-H3, the predefined objectives of the assistive system 1100 include one or more of: (i) a personal archivist objective for capturing and categorically storing data related to real-world memories of the user, (ii) a timely recall objective for providing information to the user based on determining a relevancy between data about real-world context of the user and data about a previous memory stored by the user, and/or (iii) a super capture module for capturing, enhancing, and/or performing other pre-processing and/or post-processing of images to increase quality of images captured by the one or more imaging sensors.

(H5) In some embodiments of any one of H1-H4, the instruction to capture the image data is based on one or more of: (i) performance of a long pinch gesture by the user, and/or (ii) an audio input received by the user corresponding to a wake word.

(H6) In some embodiments of any one of H1-H5, the instruction to capture the image data is based on an indication that the user is interacting with a real-world object in their real-world surroundings.

(I1) In accordance with some embodiments, a method of manufacturing includes providing a frame of a head-worn device, the frame comprising (i) a pair of lenses, (ii) one or more displays integrated into one or more lenses of the pair of lenses, and (iii) one or more front-facing cameras mounted to a peripheral rim portion of the frame. The method also includes providing a pair of temples for mechanically and electrically coupling with the frame of the head-worn device. The pair of temples collectively includes a main logic board including one or more processors for managing operations of the one or more displays integrated into the one or more lenses, the one or more front-facing cameras of the head-worn device, one or more batteries configured to provide power to electronic components in the frame or one or more of the temple arms of the head-worn device, and one or more speakers configured to mount to a peripheral portion of at least one of the temple arms of the head-worn device. Each of the components comprising the pair of temple arms is configured and arranged for a particular respective activity SKU of a plurality of activity SKUs.

(J1) In accordance with some embodiments, a method includes, at a head-worn device (e.g., smart glasses) having (i) one or more forward-facing cameras and (ii) one or more microphones, providing a user interface to a wearer of the head-worn device. The method also includes detecting a user input to activate an artificial-intelligence-assistive agent at the head-worn device. The user input is a first gesture from the gesture set including a first subset of gestures from the gesture set, the first subset of gestures including one or more universal gestures for performing one or more respective actions of a set of particular actions. The one or more respective gestures are unique to the universal gesture regardless of context, and the one or more respective gestures cannot be re-assigned (e.g., re-mapped, re-allocated) to another gesture corresponding to a different respective action. The first gesture from the gesture set includes a second subset of gestures from the gesture set of contextual gestures that are assignable to two or more different actions based on a context of an interaction by the user with the head-worn device while the user is performing the contextual gesture, and an assignable gesture that is configured to be explicitly assignable by the user.

(K1) In accordance with some embodiments, a method includes detecting a first user input at a touch-input affordance of one or more input affordances of a head-wearable device and associated with one or more commands available at the head-wearable device, and, in response to detecting the first user input, causing performance of the first user-assignable command at the head-wearable device. The touch-input affordance is associated with a first user-assignable command of the one or more commands. The method includes detecting a second user input at a button-input affordance of the one or more input affordances of the head-wearable device and associated with the one or more commands available at the head-wearable device, and, in response to detecting the second user input, causing performance of the second user-assignable command at the head-wearable device. The button-input affordance is associated with a second user-assignable command of the one or more commands. For example, as shown and described above in reference to FIGS. 12A-12F, one or more input affordances of a head-wearable device (or other wearable devices) can be associated with one or more universal gestures 1212, contextual gestures 1214, and assignable gestures 1216. FIGS. 12C-12F show one or more user interfaces for assigning one or more commands to one or more input affordances of a wearable device, such as a head-wearable device.

(K2) In some embodiments of K1, the touch-input affordance is a first touch-input affordance and the button-input affordance is a first button-input affordance. The method further includes detecting a third user input at a second touch-input affordance of the one or more input affordances, and, in response to detecting the third user input, causing performance of the first predefined command at the head-wearable device. The second touch-input affordance is associated with a first predefined command of the one or more commands The method also includes detecting a fourth user input at a second button-input affordance of the one or more input affordances, and, in response to detecting the fourth user input, causing performance of the second predefined command at the head-wearable device. The second button-input affordance is associated with a second predefined command of the one or more commands. For example, as shown and described above in reference to FIGS. 12A-12F, the one or more input affordances of a wearable device can be associated with one or more commands.

(K3) In some embodiments of K2, the first touch-input affordance and the second touch-input affordance are the same and the first user input and the third user input are distinct, and the first button-input affordance and the second button-input affordance are the same and the second user input and the fourth user input are distinct. For example, a single tap input at a capacitive touch affordance 1262 (FIGS. 12A-12F) of a head-wearable device may cause a first command to be performed and a double tap input at the capacitive touch affordance 1262 of the head-wearable device may cause a second command, distinct from the first command, to be performed.

(K4) In some embodiments of K2, the first touch-input affordance and the second touch-input affordance are distinct and the first user input and the third user input are the same, and the first button-input affordance and the second button-input affordance are distinct and the second user input and the fourth user input are the same. For example, a single-tap input at a capacitive touch affordance 1262 (FIGS. 12A-12F) of a head-wearable device may cause a first command to be performed and a single-tap input at a capacitive touch button 1268 of the head-wearable device may cause a second command, distinct from the first command, to be performed.

(K5) In some embodiments of any one of K1-K4, the one or more commands available at the head-wearable device include a plurality of predefined commands including one or more of media control commands, communication-based commands, a first set of artificial-intelligence agent control commands, and power-control commands; and a plurality of user-assignable commands including one or more of a second set of artificial-intelligence agent control commands, context-based commands, image capture commands, and application-based commands. Non-limiting examples of commands are shown and described above in reference to FIGS. 12A-12F.

(K6) In some embodiments of any one of K1-K5, the method also includes, in response to a request to associate the one or more input affordance with user-assignable commands of the one or more commands, causing the electronic device to present a first configuration user interface (UI) including a plurality of input-affordance selection UI elements. The method includes, in response to detecting a fifth user input selecting an input affordance of the one or more input affordance, causing the electronic device to present a second configuration UI including a plurality of user-assignable command selection UI elements that is associated with one or more user-assignable commands of the one or more commands available at the head-wearable device. For example, as shown and described in reference to FIGS. 12C-12F, a user can assign one or more commands to input affordances of a wearable device via UIs.

(K7) In some embodiments of any one of K1-K6, the method includes, in response to a sixth user input selecting a user-assignable command selection UI element of the plurality of user-assignable command selection UI elements, the user-assignable command selection UI element corresponding to a user-assignable command of the one or more user-assignable commands. The method also includes providing a control signal to the head-wearable device for associating the input affordance with the user-assignable command. For example, as shown and described in reference to FIGS. 12C-12F, after assigning one or more commands to input affordances of a wearable device via UIs, the wearable device can receive a control signal for associating the input affordances of the wearable device with the user-assigned commands.

(L1) In accordance with some embodiments, a system that includes one or more wrist-wearable devices and a head-wearable device, and the system is configured to perform operations corresponding to any of A1-K7.

(M1) In accordance with some embodiments, a non-transitory, computer-readable storage medium including instructions that, when executed by a computing device in communication with a head-wearable device and/or a wrist-wearable device, cause the computer device to perform operations corresponding to any of A1-K7.

(N1) In accordance with some embodiments, a method of operating a wrist-wearable device and/or a head-wearable device, including operations that correspond to any of A1-K7.

(O1) In accordance with some embodiments, a means for performing or causing performance of operations corresponding to any of A1-K7.

(P1) In accordance with some embodiments, a wearable device (a head-wearable device and/or a wrist-wearable device) configured to perform or cause performance of operations corresponding to any of A1-K7.

(Q1) In accordance with some embodiments, an intermediary processing device (e.g., configured to offload processing operations for a wrist-wearable device and/or a head-worn device (e.g., augmented-reality glasses)) configured to perform or cause performance operations corresponding to any of A1-K7.

The devices described above are further detailed below, including wrist-wearable devices, headset devices, systems, and haptic feedback devices. Specific operations described above may occur as a result of specific hardware; such hardware is described in further detail below. The devices described below are not limiting, and features on these devices can be removed or additional features can be added to these devices.

### Example Extended-Reality Systems

FIGS. 15A-15C-2 illustrate example XR systems that include AR and MR systems, in accordance with some embodiments. FIG. 15A shows a first XR system 1500a and first example user interactions using a wrist-wearable device 1526, a head-wearable device (e.g., AR device 1528), and/or a HIPD 1542. FIG. 15B shows a second XR system 1500b and second example user interactions using a wrist-wearable device 1526, an AR device 1528, and/or an HIPD 1542. FIGS. 15C-1 and 15C-2 show a third MR system 1500c and third example user interactions using a wrist-wearable device 1526, a head-wearable device (e.g., an MR device such as a VR device), and/or an HIPD 1542. As the skilled artisan will appreciate upon reading the descriptions provided herein, the above-example AR and MR systems (described in detail below) can perform various functions and/or operations.

The wrist-wearable device 1526, the head-wearable devices, and/or the HIPD 1542 can communicatively couple via a network 1525 (e.g., cellular, near field, Wi-Fi, personal area network, wireless LAN). Additionally, the wrist-wearable device 1526, the head-wearable device, and/or the HIPD 1542 can also communicatively couple with one or more servers 1530, computers 1540 (e.g., laptops, computers), mobile devices 1550 (e.g., smartphones, tablets), and/or other electronic devices via the network 1525 (e.g., cellular, near field, Wi-Fi, personal area network, wireless LAN). Similarly, a smart textile-based garment, when used, can also communicatively couple with the wrist-wearable device 1526, the head-wearable device(s), the HIPD 1542, the one or more servers 1530, the computers 1540, the mobile devices 1550, and/or other electronic devices via the network 1525 to provide inputs.

Turning to FIG. 15A, a user 1502 is shown wearing the wrist-wearable device 1526 and the AR device 1528 and having the HIPD 1542 on their desk. The wrist-wearable device 1526, the AR device 1528, and the HIPD 1542 facilitate user interaction with an AR environment. In particular, as shown by the first AR system 1500a, the wrist-wearable device 1526, the AR device 1528, and/or the HIPD 1542 cause presentation of one or more avatars 1504, digital representations of contacts 1506, and virtual objects 1508. As discussed below, the user 1502 can interact with the one or more avatars 1504, digital representations of the contacts 1506, and virtual objects 1508 via the wrist-wearable device 1526, the AR device 1528, and/or the HIPD 1542. In addition, the user 1502 is also able to directly view physical objects in the environment, such as a physical table 1529, through transparent lens(es) and waveguide(s) of the AR device 1528. Alternatively, an MR device could be used in place of the AR device 1528 and a similar user experience can take place, but the user would not be directly viewing physical objects in the environment, such as table 1529, and would instead be presented with a virtual reconstruction of the table 1529 produced from one or more sensors of the MR device (e.g., an outward facing camera capable of recording the surrounding environment).

The user 1502 can use any of the wrist-wearable device 1526, the AR device 1528 (e.g., through physical inputs at the AR device and/or built-in motion tracking of a user's extremities), a smart-textile garment, an externally mounted extremity tracking device, and/or the HIPD 1542 to provide user inputs, etc. For example, the user 1502 can perform one or more hand gestures that are detected by the wrist-wearable device 1526 (e.g., using one or more EMG sensors and/or IMUs built into the wrist-wearable device) and/or AR device 1528 (e.g., using one or more image sensors or cameras) to provide a user input. Alternatively, or additionally, the user 1502 can provide a user input via one or more touch surfaces of the wrist-wearable device 1526, the AR device 1528, and/or the HIPD 1542, and/or voice commands captured by a microphone of the wrist-wearable device 1526, the AR device 1528, and/or the HIPD 1542. The wrist-wearable device 1526, the AR device 1528, and/or the HIPD 1542 include an artificially intelligent digital assistant to help the user in providing a user input (e.g., completing a sequence of operations, suggesting different operations or commands, providing reminders, confirming a command). For example, the digital assistant can be invoked through an input occurring at the AR device 1528 (e.g., via an input at a temple arm of the AR device 1528). In some embodiments, the user 1502 can provide a user input via one or more facial gestures and/or facial expressions. For example, cameras of the wrist-wearable device 1526, the AR device 1528, and/or the HIPD 1542 can track the user 1502's eyes for navigating a user interface.

The wrist-wearable device 1526, the AR device 1528, and/or the HIPD 1542 can operate alone or in conjunction to allow the user 1502 to interact with the AR environment. In some embodiments, the HIPD 1542 is configured to operate as a central hub or control center for the wrist-wearable device 1526, the AR device 1528, and/or another communicatively coupled device. For example, the user 1502 can provide an input to interact with the AR environment at any of the wrist-wearable device 1526, the AR device 1528, and/or the HIPD 1542, and the HIPD 1542 can identify one or more back-end and front-end tasks to cause the performance of the requested interaction and distribute instructions to cause the performance of the one or more back-end and front-end tasks at the wrist-wearable device 1526, the AR device 1528, and/or the HIPD 1542. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 1542 can perform the back-end tasks and provide the wrist-wearable device 1526 and/or the AR device 1528 operational data corresponding to the performed back-end tasks such that the wrist-wearable device 1526 and/or the AR device 1528 can perform the front-end tasks. In this way, the HIPD 1542, which has more computational resources and greater thermal headroom than the wrist-wearable device 1526 and/or the AR device 1528, performs computationally intensive tasks and reduces the computer resource utilization and/or power usage of the wrist-wearable device 1526 and/or the AR device 1528.

In the example shown by the first AR system 1500a, the HIPD 1542 identifies one or more back-end tasks and front-end tasks associated with a user request to initiate an AR video call with one or more other users (represented by the avatar 1504 and the digital representation of the contact 1506) and distributes instructions to cause the performance of the one or more back-end tasks and front-end tasks. In particular, the HIPD 1542 performs back-end tasks for processing and/or rendering image data (and other data) associated with the AR video call and provides operational data associated with the performed back-end tasks to the AR device 1528 such that the AR device 1528 performs front-end tasks for presenting the AR video call (e.g., presenting the avatar 1504 and the digital representation of the contact 1506).

In some embodiments, the HIPD 1542 can operate as a focal or anchor point for causing the presentation of information. This allows the user 1502 to be generally aware of where information is presented. For example, as shown in the first AR system 1500a, the avatar 1504 and the digital representation of the contact 1506 are presented above the HIPD 1542. In particular, the HIPD 1542 and the AR device 1528 operate in conjunction to determine a location for presenting the avatar 1504 and the digital representation of the contact 1506. In some embodiments, information can be presented within a predetermined distance from the HIPD 1542 (e.g., within five meters). For example, as shown in the first AR system 1500a, virtual object 1508 is presented on the desk some distance from the HIPD 1542. Similar to the above example, the HIPD 1542 and the AR device 1528 can operate in conjunction to determine a location for presenting the virtual object 1508. Alternatively, in some embodiments, presentation of information is not bound by the HIPD 1542. More specifically, the avatar 1504, the digital representation of the contact 1506, and the virtual object 1508 do not have to be presented within a predetermined distance of the HIPD 1542. While an AR device 1528 is described working with an HIPD, an MR headset can be interacted with in the same way as the AR device 1528.

User inputs provided at the wrist-wearable device 1526, the AR device 1528, and/or the HIPD 1542 are coordinated such that the user can use any device to initiate, continue, and/or complete an operation. For example, the user 1502 can provide a user input to the AR device 1528 to cause the AR device 1528 to present the virtual object 1508 and, while the virtual object 1508 is presented by the AR device 1528, the user 1502 can provide one or more hand gestures via the wrist-wearable device 1526 to interact with and/or manipulate the virtual object 1508. While an AR device 1528 is described working with a wrist-wearable device 1526, an MR headset can be interacted with in the same way as the AR device 1528.

### Integration of Artificial Intelligence With XR Systems

FIG. 15A illustrates an interaction in which an artificially intelligent virtual assistant can assist in requests made by a user 1502. The AI virtual assistant can be used to complete open-ended requests made through natural language inputs by a user 1502. For example, in FIG. 15A, the user 1502 makes an audible request 1544 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 15A also illustrates an example neural network 1552 used in Artificial Intelligence applications. Uses of Artificial Intelligence (AI) are varied and encompass many different aspects of the devices and systems described herein. AI capabilities cover a diverse range of applications and deepen interactions between the user 1502 and user devices (e.g., the AR device 1528, an MR device 1532, the HIPD 1542, the wrist-wearable device 1526). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices and/or any other devices described herein. For devices and systems herein that employ multiple AI models, different models can be used depending on the task. For example, for a natural-language artificially intelligent virtual assistant, an LLM can be used, and for the object detection of a physical environment, a DNN can be used instead.

In another example, an AI virtual assistant can include many different AI models, and, based on the user's request, multiple AI models may be employed (concurrently, sequentially or a combination thereof). For example, an LLM-based AI model can provide instructions for helping a user follow a recipe, and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 1502 can interact with an AI model through natural language inputs captured by a voice sensor, text inputs, or any other input modality that accepts natural language and/or a corresponding voice sensor module. In another instance, input is provided by tracking the eye gaze of a user 1502 via a gaze tracker module. Additionally, the AI model can also receive inputs beyond those supplied by a user 1502. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors'data can be retrieved entirely from a single device (e.g., AR device 1528) or from multiple devices that are in communication with each other (e.g., a system that includes at least two of an AR device 1528, an MR device 1532, the HIPD 1542, the wrist-wearable device 1526, etc.). The AI model can also access additional information (e.g., one or more servers 1530, the computers 1540, the mobile devices 1550, and/or other electronic devices) via a network 1525 (e.g., internet, cellular, near field, Wi-Fi, personal area network, wireless LAN).

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 1528, an MR device 1532, the HIPD 1542, the wrist-wearable device 1526) via the one or more networks. The cloud-computing platforms provide scalable computing resources, distributed computing, managed AI services, interference acceleration, pre-trained models, APIs, and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 1528, an MR device 1532, the HIPD 1542, the wrist-wearable device 1526), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 1542), haptic feedback can provide information to the user 1502. An AI model can also use the inputs described above to determine the appropriate modality and device(s) to present content to the user (e.g., a user walking on a busy road can be presented with an audio output instead of a visual output to avoid distracting the user 1502).

### Example Augmented Reality Interaction

FIG. 15B shows the user 1502 wearing the wrist-wearable device 1526 and the AR device 1528 and holding the HIPD 1542. In the second AR system 1500b, the wrist-wearable device 1526, the AR device 1528, and/or the HIPD 1542 are used to receive and/or provide one or more messages to a contact of the user 1502. In particular, the wrist-wearable device 1526, the AR device 1528, and/or the HIPD 1542 detect and coordinate one or more user inputs to initiate a messaging application and prepare a response to a received message via the messaging application.

In some embodiments, the user 1502 initiates, via a user input, an application on the wrist-wearable device 1526, the AR device 1528, and/or the HIPD 1542 that causes the application to initiate on at least one device. For example, in the second AR system 1500b the user 1502 performs a hand gesture associated with a command for initiating a messaging application (represented by messaging user interface 1512); the wrist-wearable device 1526 detects the hand gesture; and, based on a determination that the user 1502 is wearing the AR device 1528, causes the AR device 1528 to present a messaging user interface 1512 of the messaging application. The AR device 1528 can present the messaging user interface 1512 to the user 1502 via its display (e.g., as shown by user 1502's field of view 1510). In some embodiments, the application is initiated and can be run on the device (e.g., the wrist-wearable device 1526, the AR device 1528, and/or the HIPD 1542) that detects the user input to initiate the application, and the device provides another device operational data to cause the presentation of the messaging application. For example, the wrist-wearable device 1526 can detect the user input to initiate a messaging application, initiate and run the messaging application, and provide operational data to the AR device 1528 and/or the HIPD 1542 to cause presentation of the messaging application. Alternatively, the application can be initiated and run at a device other than the device that detected the user input. For example, the wrist-wearable device 1526 can detect the hand gesture associated with initiating the messaging application and cause the HIPD 1542 to run the messaging application and coordinate the presentation of the messaging application.

Further, the user 1502 can provide a user input provided at the wrist-wearable device 1526, the AR device 1528, and/or the HIPD 1542 to continue and/or complete an operation initiated at another device. For example, after initiating the messaging application via the wrist-wearable device 1526 and while the AR device 1528 presents the messaging user interface 1512, the user 1502 can provide an input at the HIPD 1542 to prepare a response (e.g., shown by the swipe gesture performed on the HIPD 1542). The user 1502's gestures performed on the HIPD 1542 can be provided and/or displayed on another device. For example, the user 1502's swipe gestures performed on the HIPD 1542 are displayed on a virtual keyboard of the messaging user interface 1512 displayed by the AR device 1528.

In some embodiments, the wrist-wearable device 1526, the AR device 1528, the HIPD 1542, and/or other communicatively coupled devices can present one or more notifications to the user 1502. The notification can be an indication of a new message, an incoming call, an application update, a status update, etc. The user 1502 can select the notification via the wrist-wearable device 1526, the AR device 1528, or the HIPD 1542 and cause presentation of an application or operation associated with the notification on at least one device. For example, the user 1502 can receive a notification that a message was received at the wrist-wearable device 1526, the AR device 1528, the HIPD 1542, and/or other communicatively coupled device and provide a user input at the wrist-wearable device 1526, the AR device 1528, and/or the HIPD 1542 to review the notification, and the device detecting the user input can cause an application associated with the notification to be initiated and/or presented at the wrist-wearable device 1526, the AR device 1528, and/or the HIPD 1542.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1528 can present to the user 1502 game application data and the HIPD 1542 can use a controller to provide inputs to the game. Similarly, the user 1502 can use the wrist-wearable device 1526 to initiate a camera of the AR device 1528, and the user can use the wrist-wearable device 1526, the AR device 1528, and/or the HIPD 1542 to manipulate the image capture (e.g., zoom in or out, apply filters) and capture image data.

While an AR device 1528 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed to presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 15C-1 and 15C-2, the user 1502 is shown wearing the wrist-wearable device 1526 and an MR device 1532 (e.g., a device capable of providing either an entirely VR experience or an MR experience that displays object(s) from a physical environment at a display of the device) and holding the HIPD 1542. In the third AR system 1500c, the wrist-wearable device 1526, the MR device 1532, and/or the HIPD 1542 are used to interact within an MR environment, such as a VR game or other MR/VR application. While the MR device 1532 presents a representation of a VR game (e.g., first MR game environment 1520) to the user 1502, the wrist-wearable device 1526, the MR device 1532, and/or the HIPD 1542 detect and coordinate one or more user inputs to allow the user 1502 to interact with the VR game.

In some embodiments, the user 1502 can provide a user input via the wrist-wearable device 1526, the MR device 1532, and/or the HIPD 1542 that causes an action in a corresponding MR environment. For example, the user 1502 in the third MR system 1500c (shown in FIG. 15C-1) raises the HIPD 1542 to prepare for a swing in the first MR game environment 1520. The MR device 1532, responsive to the user 1502 raising the HIPD 1542, causes the MR representation of the user 1522 to perform a similar action (e.g., raise a virtual object, such as a virtual sword 1524). In some embodiments, each device uses respective sensor data and/or image data to detect the user input and provide an accurate representation of the user 1502's motion. For example, image sensors (e.g., SLAM cameras or other cameras) of the HIPD 1542 can be used to detect a position of the HIPD 1542 relative to the user 1502's body such that the virtual object can be positioned appropriately within the first MR game environment 1520; sensor data from the wrist-wearable device 1526 can be used to detect a velocity at which the user 1502 raises the HIPD 1542 such that the MR representation of the user 1522 and the virtual sword 1524 are synchronized with the user 1502's movements; and image sensors of the MR device 1532 can be used to represent the user 1502's body, boundary conditions, or real-world objects within the first MR game environment 1520.

In FIG. 15C-2, the user 1502 performs a downward swing while holding the HIPD 1542. The user 1502's downward swing is detected by the wrist-wearable device 1526, the MR device 1532, and/or the HIPD 1542 and a corresponding action is performed in the first MR game environment 1520. In some embodiments, the data captured by each device is used to improve the user's experience within the MR environment. For example, sensor data of the wrist-wearable device 1526 can be used to determine a speed and/or force at which the downward swing is performed and image sensors of the HIPD 1542 and/or the MR device 1532 can be used to determine a location of the swing and how it should be represented in the first MR game environment 1520, which, in turn, can be used as inputs for the MR environment (e.g., game mechanics, which can use detected speed, force, locations, and/or aspects of the user 1502's actions to classify a user's inputs (e.g., user performs a light strike, hard strike, critical strike, glancing strike, miss) or calculate an output (e.g., amount of damage)).

FIG. 15C-2 further illustrates that a portion of the physical environment is reconstructed and displayed at a display of the MR device 1532 while the MR game environment 1520 is being displayed. In this instance, a reconstruction of the physical environment 1546 is displayed in place of a portion of the MR game environment 1520 when object(s) in the physical environment are potentially in the path of the user (e.g., a collision with the user and an object in the physical environment are likely). Thus, this example MR game environment 1520 includes (i) an immersive VR portion 1548 (e.g., an environment that does not have a corollary counterpart in a nearby physical environment) and (ii) a reconstruction of the physical environment 1546 (e.g., table 1550 and cup 1552). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 1526, the MR device 1532, and/or the HIPD 1542 are described as detecting user inputs, in some embodiments, user inputs are detected at a single device (with the single device being responsible for distributing signals to the other devices for performing the user input). For example, the HIPD 1542 can operate an application for generating the first MR game environment 1520 and provide the MR device 1532 with corresponding data for causing the presentation of the first MR game environment 1520, as well as detect the user 1502's movements (while holding the HIPD 1542) to cause the performance of corresponding actions within the first MR game environment 1520. Additionally or alternatively, in some embodiments, operational data (e.g., sensor data, image data, application data, device data, and/or other data) of one or more devices is provided to a single device (e.g., the HIPD 1542) to process the operational data and cause respective devices to perform an action associated with processed operational data.

In some embodiments, the user 1502 can wear a wrist-wearable device 1526, wear an MR device 1532, wear smart textile-based garments 1538 (e.g., wearable haptic gloves), and/or hold an HIPD 1542 device. In this embodiment, the wrist-wearable device 1526, the MR device 1532, and/or the smart textile-based garments 1538 are used to interact within an MR environment (e.g., any AR or MR system described above in reference to FIGS. 15A-15B). While the MR device 1532 presents a representation of an MR game (e.g., second MR game environment 1520) to the user 1502, the wrist-wearable device 1526, the MR device 1532, and/or the smart textile-based garments 1538 detect and coordinate one or more user inputs to allow the user 1502 to interact with the MR environment.

In some embodiments, the user 1502 can provide a user input via the wrist-wearable device 1526, an HIPD 1542, the MR device 1532, and/or the smart textile-based garments 1538 that causes an action in a corresponding MR environment. In some embodiments, each device uses respective sensor data and/or image data to detect the user input and provide an accurate representation of the user 1502's motion. While four different input devices are shown (e.g., a wrist-wearable device 1526, an MR device 1532, an HIPD 1542, and a smart textile-based garment 1538) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 1538) sensor fusion can be utilized to ensure inputs are correct. While multiple input devices are described, it is understood that other input devices can be used in conjunction or on their own instead, such as, but not limited to, external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 1538 can be used in conjunction with an MR device and/or an HIPD 1542.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing, and/or data transfer between the respective electronic devices and/or electronic components.

The foregoing descriptions of FIGS. 15A-15C-2 provided above are intended to augment the description provided in reference to FIGS. 1A-14. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,”, is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A system, comprising:
one or more processors communicatively coupled with:
a head-wearable device including one or more input affordances associated with one or more commands available at the head-wearable device,
memory including executable instructions that, when executed by the one or more processors, cause the one or more processors to perform:
detecting a first user input at a touch-input affordance of the one or more input affordances, the touch-input affordance associated with a first user-assignable command of the one or more commands;
in response to detecting the first user input, causing performance of the first user-assignable command at the head-wearable device;
detecting a second user input at a button-input affordance of the one or more input affordances, the button-input affordance associated with a second user-assignable command of the one or more commands; and
in response to detecting the second user input, causing performance of the second user-assignable command at the head-wearable device.

2. The system of claim 1, wherein the touch-input affordance is a first touch-input affordance and the button-input affordance is a first button-input affordance, and the instructions, when executed by the one or more processors, further cause the one or more processors to perform:
detecting a third user input at a second touch-input affordance of the one or more input affordances, the second touch-input affordance associated with a first predefined command of the one or more commands;
in response to detecting the third user input, causing performance of the first predefined command at the head-wearable device;
detecting a fourth user input at a second button-input affordance of the one or more input affordances, the second button-input affordance associated with a second predefined command of the one or more commands; and
in response to detecting the fourth user input, causing performance of the second predefined command at the head-wearable device.

3. The system of claim 2, wherein:
the first touch-input affordance and the second touch-input affordance are the same and the first user input and the third user input are distinct; and
the first button-input affordance and the second button-input affordance are the same and the second user input and the fourth user input are distinct.

4. The system of claim 2, wherein:
the first touch-input affordance and the second touch-input affordance are distinct and the first user input and the third user input are the same; and
the first button-input affordance and the second button-input affordance are distinct and the second user input and the fourth user input are the same.

5. The system of claim 1, wherein the one or more commands available at the head-wearable device comprise:
a plurality of predefined commands including one or more of media control commands, communication-based commands, a first set of artificial-intelligence agent control commands, and power-control commands; and
a plurality of user-assignable commands including one or more of a second set of artificial-intelligence agent control commands, context-based commands, image capture commands, and application-based commands.

6. The system of claim 1, wherein the one or more processors are communicatively coupled with an electronic device and the instructions, when executed by the one or more processors, further cause the one or more processors to perform:
in response to a request to associate the one or more input affordance with user-assignable commands of the one or more commands, causing the electronic device to present a first configuration user interface (UI) including a plurality of input-affordance selection UI elements; and
in response to detecting a fifth user input selecting an input affordance of the one or more input affordance, causing the electronic device to present a second configuration UI including a plurality of user-assignable command selection UI elements that is associated with one or more user-assignable commands of the one or more commands available at the head-wearable device.

7. The system of claim 5, wherein the instructions, when executed by the one or more processors, further cause the one or more processors to perform:
in response to a sixth user input selecting a user-assignable command selection UI element of the plurality of user-assignable command selection UI elements, the user-assignable command selection UI element corresponding to a user-assignable command of the one or more user-assignable commands; and
providing a control signal to the head-wearable device for associating the input affordance with the user-assignable command.

8. A method, comprising:
detecting a first user input at a touch-input affordance of one or more input affordances of a head-wearable device and associated with one or more commands available at the head-wearable device, the touch-input affordance associated with a first user-assignable command of the one or more commands;
in response to detecting the first user input, causing performance of the first user-assignable command at the head-wearable device;
detecting a second user input at a button-input affordance of the one or more input affordances of the head-wearable device and associated with the one or more commands available at the head-wearable device, the button-input affordance associated with a second user-assignable command of the one or more commands; and
in response to detecting the second user input, causing performance of the second user-assignable command at the head-wearable device.

9. The method of claim 8, wherein the touch-input affordance is a first touch-input affordance and the button-input affordance is a first button-input affordance, and the method further comprises:
detecting a third user input at a second touch-input affordance of the one or more input affordances, the second touch-input affordance associated with a first predefined command of the one or more commands;
in response to detecting the third user input, causing performance of the first predefined command at the head-wearable device;
detecting a fourth user input at a second button-input affordance of the one or more input affordances, the second button-input affordance associated with a second predefined command of the one or more commands; and
in response to detecting the fourth user input, causing performance of the second predefined command at the head-wearable device.

10. The method of claim 9, wherein:
the first touch-input affordance and the second touch-input affordance are the same and the first user input and the third user input are distinct; and
the first button-input affordance and the second button-input affordance are the same and the second user input and the fourth user input are distinct.

11. The method of claim 9, wherein:
the first touch-input affordance and the second touch-input affordance are distinct and the first user input and the third user input are the same; and
the first button-input affordance and the second button-input affordance are distinct and the second user input and the fourth user input are the same.

12. The method of claim 8, wherein the one or more commands available at the head-wearable device comprise:
a plurality of predefined commands including one or more of media control commands, communication-based commands, a first set of artificial-intelligence agent control commands, and power-control commands; and
a plurality of user-assignable commands including one or more of a second set of artificial-intelligence agent control commands, context-based commands, image capture commands, and application-based commands.

13. The method of claim 8, further comprising:
in response to a request to associate the one or more input affordance with user-assignable commands of the one or more commands, causing an electronic device to present a first configuration user interface (UI) including a plurality of input-affordance selection UI elements; and
in response to detecting a fifth user input selecting an input affordance of the one or more input affordance, causing the electronic device to present a second configuration UI including a plurality of user-assignable command selection UI elements that is associated with one or more user-assignable commands of the one or more commands available at the head-wearable device.

14. The method of claim 8, further comprising:
in response to a sixth user input selecting a user-assignable command selection UI element of the plurality of user-assignable command selection UI elements, the user-assignable command selection UI element corresponding to a user-assignable command of the one or more user-assignable commands; and
providing a control signal to the head-wearable device for associating the input affordance with the user-assignable command.

15. A non-transitory computer-readable storage medium including instructions that, when executed by one or more processors of a system communicatively coupled with a head-wearable device, cause the one or more processors to perform:
detecting a first user input at a touch-input affordance of one or more input affordances of the head-wearable device and associated with one or more commands available at the head-wearable device, the touch-input affordance associated with a first user-assignable command of the one or more commands;
in response to detecting the first user input, causing performance of the first user-assignable command at the head-wearable device;
detecting a second user input at a button-input affordance of the one or more input affordances of the head-wearable device and associated with the one or more commands available at the head-wearable device, the button-input affordance associated with a second user-assignable command of the one or more commands; and
in response to detecting the second user input, causing performance of the second user-assignable command at the head-wearable device.

16. The non-transitory computer-readable storage medium of claim 15, wherein the touch-input affordance is a first touch-input affordance and the button-input affordance is a first button-input affordance, and the instructions, when executed by the one or more processors, further cause the one or more processors to perform:
detecting a third user input at a second touch-input affordance of the one or more input affordances, the second touch-input affordance associated with a first predefined command of the one or more commands;
in response to detecting the third user input, causing performance of the first predefined command at the head-wearable device;
detecting a fourth user input at a second button-input affordance of the one or more input affordances, the second button-input affordance associated with a second predefined command of the one or more commands; and
in response to detecting the fourth user input, causing performance of the second predefined command at the head-wearable device.

17. The non-transitory computer-readable storage medium of claim 16, wherein:
the first touch-input affordance and the second touch-input affordance are the same and the first user input and the third user input are distinct; and
the first button-input affordance and the second button-input affordance are the same and the second user input and the fourth user input are distinct.

18. The non-transitory computer-readable storage medium of claim 16, wherein:
the first touch-input affordance and the second touch-input affordance are distinct and the first user input and the third user input are the same; and
the first button-input affordance and the second button-input affordance are distinct and the second user input and the fourth user input are the same.

19. The non-transitory computer-readable storage medium of claim 15, wherein the one or more commands available at the head-wearable device comprise:
a plurality of predefined commands including one or more of media control commands, communication-based commands, a first set of artificial-intelligence agent control commands, and power-control commands; and
a plurality of user-assignable commands including one or more of a second set of artificial-intelligence agent control commands, context-based commands, image capture commands, and application-based commands.

20. The non-transitory computer-readable storage medium of claim 15, wherein the system is communicatively coupled with an electronic device, and the instructions, when executed by the one or more processors, further cause the one or more processors to perform:
in response to a request to associate the one or more input affordance with user-assignable commands of the one or more commands, causing the electronic device to present a first configuration user interface (UI) including a plurality of input-affordance selection UI elements; and
in response to detecting a fifth user input selecting an input affordance of the one or more input affordance, causing the electronic device to present a second configuration UI including a plurality of user-assignable command selection UI elements that is associated with one or more user-assignable commands of the one or more commands available at the head-wearable device.
